(19) United States
(12) Patent Application Publication
(10) Pub. No.: US 2024/0042691 A1
(43) Pub. Date: Feb. 8, 2024

(54) ADDITIVE MANUFACTURING USING LIGHT STEERING AND/OR DYNAMIC BEAM SHAPING

(71) Applicant: MTT Innovation Incorporated, Vancouver (CA)

(72) Inventors: Sam BULS, Haacht (BE); Andra ST QUINTIN, Vancouver (CA); Raveen KUMARAN, Vancouver (CA)

(21) Appl. No.: 18/491,731

(22) Filed: Oct. 20, 2023

Related U.S. Application Data
(63) Continuation of application No. PCT/CA2022/050709, filed on May 5, 2022.
(60) Provisional application No. 63/185,429, filed on May 7, 2021.

(51) Int. Cl. B29C 64/291; B29C 64/282; B29C 64/153; B29C 64/273

(52) U.S. Cl. CPC B29C 64/291; B29C 64/282; B29C 64/153; B29C 64/273; B33Y 30/00

(57) ABSTRACT

Apparatus for additive manufacturing includes a light source that emits light into an optical path that extends to a powder bed or other platform for additive manufacturing. A phase modulator in the optical path is controlled to present a 2D pattern of phase shifts that steer the light to provide a desired pattern of optical power density on the powder bed. In some embodiments the optical path includes elements that focus the light into a small spot on the powder bed and a scanner operative to scan the spot over the powder bed. In some embodiments the light from the optical path is distributed over an area of the powder bed. A pattern of optical power density within the spot or area may be altered by changing the data controlling the phase modulator.

### CROSS-REFERENCE TO RELATED APPLICATION

This application is a continuation of Patent Cooperation Treaty (PCT) application No. PCT/CA2022/050709 having an international filing date of 5 May 2022, which in turn claims priority from, and for the purposes of the US the benefit under 35 U.S.C. § 119 of, U.S. application No. 63/185,429 filed 7 May 2021 and entitled ADDITIVE MANUFACTURING USING LIGHT STEERING AND/OR DYNAMIC BEAM SHAPING. All of the applications referred to in this paragraph are hereby incorporated herein by reference.

### FIELD

This technology relates to additive manufacturing (AM). Embodiments of the technology may be applied to additive manufacturing using any of a wide range of materials including polymers and plastics. However, the technology is particularly useful in applications which require high temperatures. Some embodiments provide methods and systems for fabricating parts of materials that require high temperatures to yield parts such as parts made of metal, cermet (mixtures of metals and ceramics) and the like.

### BACKGROUND

Additive manufacturing is an approach to making parts (in this disclosure a “part” can be any desired object) by incrementally adding material to achieve a desired three dimensional form. Additive manufacturing is in contrast to subtractive manufacturing which starts with a solid piece of material and selectively removes material to achieve a desired three dimensional form. Additive manufacturing processes can be used to produce parts having geometries that range from simple to very complex. While one could conceive of parts that are difficult or impossible to make using a particular additive manufacturing technology, additive manufacturing technologies in general can be very flexible and capable of making parts having any of a vast range of forms from a wide range of materials.

Some additive manufacturing methods form parts layer by layer. Each layer is made by applying a layer of a flowable material (e.g. a powder or a liquid) and selectively solidifying regions or sections of the flowable material by applying optical energy. The solidified regions may be bonded to solidified regions of a previous layer to build up a part having a desired 3D geometry layer-by-layer.

The optical energy is typically applied by scanning a laser spot over the layer in a raster pattern while controlling the laser to deliver optical energy to the regions of the layer to be solidified. In general, solidification may occur by chemical processes (e.g. heat-initiated polymerization) and/or physical processes (e.g. melting or sintering).

One class of additive manufacturing applies powder-bed-fusion-processes. In a powder bed fusion process, successive layers of a powdered material are deposited. Selected regions of each layer are heated with a focused laser spot to cause particles of the powder to fuse together and to fuse to solidified regions of an adjacent layer. The layers are successively patterned to form one or more complete parts each having a desired three dimensional form.

Powder bed fusion processes may be used to make parts of a wide range of materials such as metals, polymers, ceramics, cermets, glasses, etc. The layers typically have thicknesses in the range of about 0.02 mm to 0.15 mm. The following references describe various additive manufacturing apparatuses and processes that apply powder beds:
EP 2732890 A machine for making three-dimensional objects from powdered materials
GB201711790 Photographic reconstruction procedure for powder bed fusion additive manufacturing
U.S. Ser. No. 10/518,328 Additive manufacturing system and method
US20170144372 Powder-Bed-Based Additive Production Method And Installation For Carrying Out Said Method
US20180207722 Additive manufacturing by spatially controlled material fusion
US20180272473 System And Method For Additively Manufacturing By Laser Melting Of A Powder Bed
US20190009338 Powder bed fusion apparatus and methods
US20190176404 Powder delivery device and powder delivery method for providing raw material powder to a powder application device of a powder bed fusion apparatus
US20170326816 Systems and methods for volumetric powder bed fusion
US20190134746 Device for powder bed-based generative production of metallic components
US20190291348 Additive manufacturing power map to mitigate defects
US20190193160 Method for generating a component by a power-bed-based additive manufacturing method and powder for use in such a method
US20200016838 Powder bed fusion apparatus and methods
WO201876876 Additive manufacturing method and additive manufacturing device detecting powder bed surface distension in real-time
WO201905602 Large Scale High Speed Precision Powder Bed Fusion Additive Manufacturing
WO2019175556 Methods and apparatus for powder bed additive manufacturing
WO201981894 Powder bed fusion apparatus
WO2020072986 COORDINATED CONTROL FOR FORMING THREE-DIMENSIONAL OBJECTS
WO2020222695 Process for producing a steel workpiece by additive powder bed fusion manufacturing, and steel workpiece obtained therefrom
WO2020234526 Device and method for additive manufacturing by laser powder bed fusion
WO202025949 Powder bed fusion apparatus and methods

Different names have been used to describe powder bed fusion processes depending on the materials used and/or whether powder in a powder bed is solidified by melting particles or sintering the particles. For example:
Selective Laser Melting (SLM) also known as Laser Powder Bed Fusion (L-PBF) uses a high power laser beam to fuse particles of a material together by melting the material.
Selective Laser Sintering (SLS) uses a high power laser beam to fuse particles of a powder material such as plastic, metal, ceramic, or amorphous (glassy) materials into a mass that has a desired 3-dimensional shape.
Direct Laser Metal Sintering (DLMS) is an additive manufacturing technique that uses a high power laser beam to fuse particles of a metal powder by sintering.

Apparatus for powder bed fusion typically includes a laser light source arranged to direct a laser beam into an optical path that includes a scanner that can be controlled to scan a laser spot over a powder bed. For example, the scanner may be controlled to scan the laser spot over an area of the powder bed in parallel, straight lines that are spaced closely enough together to ensure that all regions between adjacent lines can be solidified, if desired. Whether or not the powder particles are caused to form a solid mass (e.g. by melting or sintering) at any point along one of the lines may be controlled by modulating the power of the laser beam. The optical system may include a system of lenses, prisms, mirrors, etc. arranged to focus and control the scanning pattern of the laser beam.

A typical commercially available system for making parts by selective laser melting includes a mid- to high-power fiber, single mode, laser source that delivers a laser beam with a Gaussian energy distribution in cross-section. A Gaussian energy distribution is favorable from an optical perspective.

One type of scanner is a “galvano scanner” that includes a pair of mirrors that can each be pivoted about a corresponding axis in response to electrical control signals. The moveable mirrors are operable to scan a focused laser beam to any position in a two dimensional field. Although “galvano” refers to “galvanometer”, which is a type of actuator that may be used to pivot mirrors. In this document, “galvano scanner” refers to a scanner that has mirrors driven to change angle by any suitable mechanism and “galvano mirror” means a mirror having an angle that is controlled by any suitable mechanism.

Non-linear behavior of galvano mirrors can cause imperfections in the patterning. See for example, Hariri A, Fatima A, Avanaki M R N (2018) A Novel Library for the Correction of a Galvo-Scanner's Non-Linearity at High Frequencies. Res J Opt Photonics 2:2 and Buls, Sam & Craeghs, Tom & Clijsters, Stijn & Kempen, Karolien & Swevers, Jan & Kruth, Jean-Pierre. The influence of a dynamically optimized galvano based laser scanner on the total scan time of SLM parts. 24th International SFF Symposium, Austin, Texas USA (2013).

Another type of scanner includes a gantry equipped with motors operable to move a laser source in X and Y directions. Such scanners may be too slow for some applications (e.g. patterning larger powder beds).

Another type of scanner combines a motorized gantry and a galvano scanner carried by the gantry. The gantry may be operated to position the galvano scanner, and thus its scanning field, over different regions of the powder bed which can then be patterned to provide features using a light beam directed by the galvano scanner. A main benefit of this architecture is to provide a relatively low cost machine that can make large parts with a desired resolution. A disadvantage of this architecture is that the patterned layer may have ‘stitching’ defects at the interfaces where the patterning was made at different regions.

Successful manufacture of high quality parts by powder bed fusion requires precision control over temperatures in the powder bed at both large and small length scales. At locations where the powder bed is to be solidified the temperature must be elevated sufficiently to sinter, melt or otherwise solidify the powder bed. At other locations in the powder bed the temperature should be kept low enough that the powder bed is not solidified and low enough so that heat from the powder bed does not cause problems with the additive manufacturing apparatus. Even in regions of the powder bed which should be solidified the temperature should not be too high. Excessive temperatures can cause defects.

Temperatures in a powder bed can be affected by multiple parameters such as laser power, preheating of the powder bed, etc. These parameters are interlinked and are also material dependent.

Environmental conditions such as temperature, humidity, oxygen levels, etc. can also influence quality of parts made by powder bed fusion. Factors such as powder flowability, ability to maintain temperature, and sinterability of the powder can all be affected by environmental conditions.

Managing heat in powder bed additive manufacturing is complicated, especially when making intricate parts to high precision. Defects can be caused if too little or too much heat is applied at a point in a powder bed that should be solidified or if too much heat is applied at a point in the powder bed that should not be solidified. The overall temperature of a powder bed can affect how quickly a material cools after it has been melted or sintered. The cooling rate can significantly affect properties of some materials. Also, heat applied at one point in a powder bed will spread to adjacent points. Managing heat can be a particular problem when the material of the powder bed requires high processing temperatures and when it is desired to increase process speeds.

Various approaches may be tried to decrease process time so that parts may be made at a higher rate. For example, one can select a parameter set that allows higher process speed. Unfortunately, most parameter selections that allow higher process speed also result in decreased part quality. Preheating a powder bed can help to achieve higher process speed by providing additional choices for process parameters.

Most commercially available SLM 3D printers for making metal parts include heaters (e.g. resistive heaters) arranged to heat the powder bed before the laser beam is applied to pattern a top layer of the powder bed. At least in part due to design constraints that limit the positions at which heaters can be located, the heaters cannot usually maintain the powder bed at a constant temperature. It is common for powder temperature to vary by 10-15° C. or more across the build surface of the powder bed. The laser beam(s) used to bring selected points on the powder bed to sintering or melting temperatures also contribute to the thermal profile of the powder bed.

Additive manufacturing of intricate metal parts is an area of significant commercial value. Making metal parts by powder bed fusion is particularly challenging because of the high temperatures required to sinter or melt many metals of interest. The need to achieve such high temperatures makes thermal management particularly challenging.

Another issue is that the temperatures sufficient to sinter or melt metals in a region of a powder bed cannot be practically achieved at high scanning speeds. Thus it is difficult to increase the rate at which metal parts can be produced by powder bed fusion techniques. It is not possible to achieve higher scanning speeds by simply increasing the power of the laser beam. At high laser powers for typical laser beam energy profiles a melt pool can become unstable, ‘key-hole’ defects may be formed and/or excessive evaporation of the powder material may occur. Any of these issues can result in unacceptable parts.

One way to reduce or avoid some of the problems caused by higher laser power densities is to perform beam shaping to achieve non-Gaussian beam profiles. Alternative laser beam profiles such as donut, tail, and multi-spot profiles have been demonstrated to facilitate significant process speed improvement. However, current beam shaping technology has limitations such as requiring physical optical components to be changed or rotated to alter the energy distribution of the laser source.

One way to decrease process time is to add additional laser beams. For example, the time required to process one layer of a powder bed can be cut in half by simultaneously using two laser beams instead of one laser beam to scan the bed. A multi-beam approach is disclosed in EP 07 244 94 B1. However, increasing the number of lasers can increase cost significantly.

Another issue is that the parameters that may be chosen to facilitate efficient making of a metal part may not be conducive to providing the part with desired metallurgical properties. For example, the microstructure, density and/or surface qualities may be less than ideal. Frequently, the ranges within which parameters such as laser beam power, scanning speed, initial powder bed temperature, etc. can be adjusted while maintaining overall process efficiency (i.e. the “process window”) are too small to optimize metallurgical properties of the resulting parts. Remelting is sometimes done in an attempt to improve metallurgical characteristics of a finished part.

Despite the rapid developments that have been made in the field of additive manufacturing, there remains a need for improved processes and apparatus for making parts by additive manufacturing, particularly by powder bed fusion, particularly for parts made of metal.

### SUMMARY

This invention has a range of aspects. These include, without limitation:
Methods for additive manufacturing by powder bed fusion that apply spatial phase modulation to steer light to selectively heat different points in a powder layer;
Methods for additive manufacturing that apply spatial phase modulation to perform dynamic shaping and/or dynamic control over energy distribution profiles of scanned energy beams;
Methods of additive manufacturing that combine steered light with scanned beams;
Apparatus for additive manufacturing;
Computer program products carrying executable instructions for controlling additive manufacturing apparatus and/or for processing data defining a part in preparation for making the part by additive manufacturing.

A wide range of aspects of the invention and example embodiments are illustrated in the accompanying drawings, described in the following disclosure and/or recited in the appended claims.

One aspect of the invention provides apparatus for additive manufacturing. The apparatus comprises a platform configured to support a powder bed and a light source operable to emit a beam of light into an optical path extending to a location of the powder bed. The optical path includes a phase modulator having an active area comprising a two-dimensional array of pixels. The pixels are individually controllable to apply phase shifts to light interacting with the pixels. A controller is connected to configure the pixels of the phase modulator to apply selected patterns of phase shifts to light incident on the active area of the phase modulator such that an energy density profile of the light incident at the location of the powder bed is determined at least in part by a current pattern of phase shifts applied by the phase modulator. The controller may be configured to control the beam of light at least in part by controlling the phase modulator to selectively solidify portions of a top layer of the powder bed, for example, by sintering particles in the top layer of the powder bed and/or melting particles in the top layer of the powder bed.

In some embodiments the controller is configured to apply preheating and/or post-heating to the powder bed prior to the solidifying.

Another aspect of the invention provides apparatus for additive manufacturing comprising a platform configured to support a powder bed and a system for selectively solidifying the powder bed. The system comprises one or more of:
two or more scanning units, each of the scanning units operable to scan at least one beam over a field that covers all or a selected area within the powder bed;
one or more exposure units and one or more scanning units each operable to direct light onto an area of the powder bed; and two or more exposure units each operable to expose all or a corresponding area within the powder bed.

Another aspect of the invention provides computer program products that comprise a computer readable medium carrying computer executable instructions that, when executed by a data processor of a controller of apparatus for additive manufacturing cause the data processor to control the apparatus as described herein.

Another aspect of the invention provides methods of additive manufacturing that comprise: guiding light from a light source to the location of a powder bed on an optical path that includes a phase modulator; controlling the phase modulator to apply a 2D pattern of phase shifts to the light, the phase shifts steering the light onto the powder bed to yield a desired optical power distribution on the powder bed; and the optical power distribution selectively solidifying areas in a top layer of the powder bed. Another aspect of the invention provides methods for the additive manufacturing of parts that method comprising: making a Computer Aided Design (CAD) data defining a part; processing the CAD data to yield layer data, wherein a layer represents a single slice of the part with a certain layer thickness and the layer data includes a pattern which indicates areas within the corresponding layer of the powder bed which should be solidified; determining phase patterns for one or more phase modulators, which for each layer will steer light to the areas of the powder bed which should be solidified; determining process parameters for creating each layer of the part; initializing the powder bed with a first layer; and until the part is complete repeating the steps of: retrieving the phase pattern for the current layer and setting a phase modulator of an exposure unit according to the phase pattern; controlling the exposure unit to expose the current layer sufficiently to solidify those areas of the current layer that should be solidified according to the layer data for the current layer; and adding a new layer of powder to the powder bed.

In various embodiments, 2D patterns of phase shifts applied to a beam of light by one or more 2D phase modulators cause a power distribution of the light when projected onto a powder bed to take a desired form. The power distribution may, for example, comprise a power distribution in a scanned spot of laser light or a power distribution over a much larger area of a powder bed (up to an entire powder bed). The power distribution may be dynamically varied to achieve desired objectives such as, for example well-defined edges of a part, desired uniformity or non-uniformity of solidification of the powder bed (e.g. by sintering or melting).

It is emphasized that the invention relates to all combinations of the features described, recited and/or illustrated in this application, even if these are recited in different claims, described in different paragraphs or sentences or sections or illustrated in different drawings.

### BRIEF DESCRIPTION OF THE DRAWINGS

The accompanying drawings illustrate non-limiting example embodiments of the invention.

FIG. 1 is a schematic elevational cross section view of an additive manufacturing apparatus according to an example embodiment.

FIG. 1A is a schematic view of an example additive manufacturing apparatus. FIG. 1B shows an example pattern for a layer of a powder bed. FIG. 1C is a schematic view of an example additive manufacturing apparatus with plural exposure units.

FIG. 2 is a plan view showing optical components of an example exposure system of the general type shown in FIG. 1A.

FIG. 3 is a perspective view of an optical splitter/combiner assembly of the exposure system of FIG. 2.

FIG. 4A is a schematic view of an example beam shaping unit. FIG. 4B is a cross-sectional view of the beam shaping unit of FIG. 4A.

FIG. 5A is an elevation view of an example phase modulator assembly. FIG. 5B is a perspective view of the phase modulator assembly of FIG. 5A.

FIG. 6 is a perspective view of an example optical folding unit.

FIG. 7 is a block diagram of an example additive manufacturing apparatus that implements dynamic beam shaping of a scanned beam.

FIG. 8A is a schematic view of a scanner that has a focus lens having a fixed focal length. FIG. 8B is a schematic view of a scanner that has a f-θ lens. FIG. 8C is schematic view of a scanner that has a phase modulator with a dynamically varying phase pattern that simulates a flat field lens or a f-θ lens.

FIG. 9A is a schematic illustration showing distortions of boundary lines that can result from the geometry of a galvano scanner. FIG. 9B is a schematic view of the distortion of boundaries lines as shown in FIG. 9A.

FIG. 10 is a schematic illustration showing how distortion of beam shapes by a galvano scanner may be corrected.

FIG. 11 is a schematic illustration showing a region of overlap between fields of two scanner units.

FIG. 12 is a perspective view of optical components of an example additive manufacturing apparatus.

FIGS. 12A, 12B and 12C are plots that respectively illustrate: an example symmetrical Gaussian power density distribution; an example donut power density distribution and an example plateau power density distribution. FIGS. 12D, 12E and 12F are the corresponding top views of the power density distributions depicted in FIGS. 12A, 12B and 12C respectively.

FIG. 13 is a block diagram showing an example apparatus with sensors that monitor light characteristics.

FIG. 14 is a block diagram showing an example apparatus that implements combined light steering and laser scanning.

FIG. 15 is a flow chart showing a method of manufacturing a part using apparatus similar to that shown in FIG. 13. FIG. 15A is a data flow diagram illustrating flows of data in an example method.

FIGS. 16A, 16B and 16C are schematic views of example strategies for patterning 2D regions using one or more exposure units.

FIGS. 17A, 17B and 17C are schematic views of example strategies for patterning 2D regions which combine exposure with steered light and exposure with scanned light.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

One aspect of the present invention provides apparatuses for additive manufacturing. Such apparatuses may include one or both of:
a system for directing patterns of energy to a two dimensional region; and
a scanning system which includes a dynamic beam shaper/profiler operable to vary a shape and/or energy distribution of an energy beam in real time as the beam is being scanned.

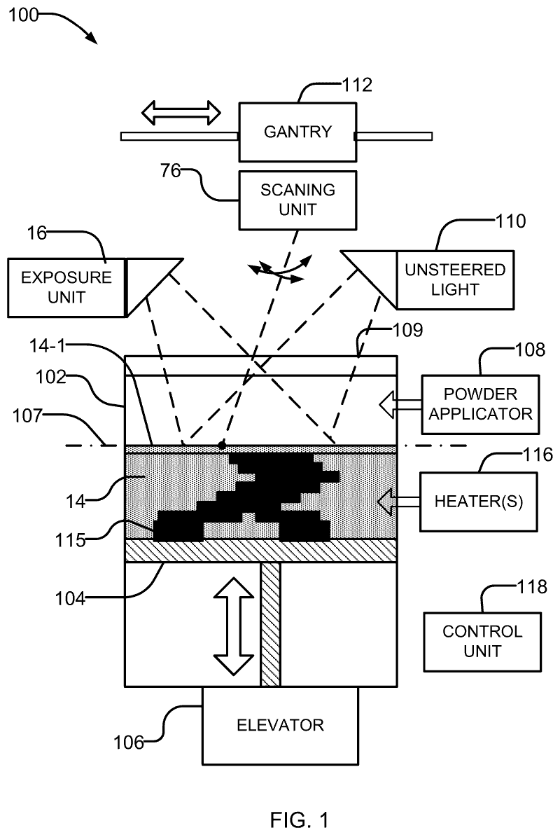

FIG. 1 shows an example additive manufacturing apparatus 100. Apparatus 100 comprises an atmosphere controlled enclosure 102. In some embodiments, enclosure 102 is evacuated or partially evacuated or filled with an inert gas such as argon or helium or a relatively non-reactive gas such as nitrogen. A platform 104 is provided inside enclosure 102. Platform 104 supports a powder bed 14. The vertical elevation of platform 104 is adjustable by an elevator 106 to maintain a top surface of powder bed 14 at a fixed elevation 107.

A powder applicator 108 is operative to add layers to a top of powder bed 14. A topmost layer 14-1 that has not yet been patterned is shown. Layers of powder bed 14 are patterned by directing optical energy onto powder bed 14 through a window 109.

Apparatus 100 includes several sources of optical energy. These include an exposure unit 16 that is operable to project 2D patterns of optical radiation onto a top surface of powder bed 14, a scanning unit 76 operable to scan a focused beam of light across the top surface of powder bed 14 and a source of unsteered light 110 operable to illuminate all or part of the top surface of powder bed 14 with light.

Scanning unit 76 is optionally supported on a gantry 112 operable to move scanning unit 76 relative to powder bed 14 in one or two dimensions (e.g. gantry 112 may be an X-Y gantry).

Portions of powder bed 14 may be solidified by directing optical energy at the top surface of powder bed 14 from light sources 16, 76 and/or 110. Previously solidified areas of layers of powder bed 14 below top layer 14-1 are indicated by 115.

Apparatus 100 includes one or more heaters 116 operable to direct heat into powder bed 14. A control unit 118 (which may be distributed among two or more hardware components) is connected by data connections (not shown) to control operation of apparatus 100 to form parts by selectively solidifying volumes of powder bed 14. Further details of various example components that may be included in apparatus 100 are described below.

Apparatus 100 may be modified in various ways, for example by one or any combination of:
exposure unit 16 or scanning unit 76 may be omitted;
more exposure units 16 and/or more scanning units 76 may be provided;
unsteered light source 110 may be omitted or more unsteered light sources may be provided;
means such as a gantry or robot may be provided for moving exposure unit 16 relative to powder bed 14;
some or all of the light sources may be mounted directly above powder bed 14;
for some applications enclosure 102 may be filled with air or a reactive gas.

### 1: Light-Steering Broad Area Illumination

FIG. 1A shows schematically an example additive manufacturing apparatus 10. Apparatus 10 includes a surface 12 that supports a powder bed 14. A powder applicator 15 is operative to add layers to powder bed 14 as a part is formed.

Apparatus 10 includes an exposure system 16 that simultaneously applies energy to a two dimensional (“2D”) area of powder bed 14. The two dimensional area may cover all of powder bed 14 or all of an area of powder bed 14 in which a particular part is being formed or another two dimensional area of powder bed 14. In some embodiments the two dimensional area has dimensions of 300 mm by 300 mm or more.

Apparatus 10 may be operated to make one or more parts that have defined shapes by sequentially processing layers of powder bed 14. A plan for each layer may specify certain regions or sections of the powder bed to be solidified. The regions to be solidified may have shapes that correspond to various features of one or more parts. Example features are walls, thin walls, corners, solid volumes, boundaries of openings, and the like.

The applied energy may be used for preheating powder bed 14, fusing particles of powder bed 14 by sintering or melting and/or adjusting a profile of temperature vs time post fusion (e.g. controlling cool down). For solidifying areas of powder bed 14 the applied energy is patterned in that the applied energy has a high intensity at locations where it is desired to solidify a layer of powder bed 14 and a lower intensity at locations where it is not intended to solidify the layer of powder bed 14. For control of cool down, the applied energy may be patterned to concentrate energy in areas of powder bed 14 where it is desired to reduce a rate of cooling of solidified material of powder bed 14. For preheating powder bed 14 the applied energy may be patterned to, for example:
concentrate more energy in portions of areas of powder bed 14 that are to be solidified that are away from edges of such areas;
concentrate more energy in areas of powder bed 14 that are cooler than desired; and/or
concentrate more energy in areas of powder bed 14 that are to be solidified next.

Exposure system 16 includes a laser 16A which is operative to emit a laser beam 16B. Beam 16B illuminates a phase modulator 16C. Phase modulator 16C comprises an array of pixels that are individually controllable to alter a phase of the portion of the laser beam that interacts with the pixel by a controllable amount. The pixels of phase modulator 16C are controlled by a controller to present a phase pattern that causes light from the laser beam to be steered to form a pattern of light that has a desired spatial and/or temporal variation of intensity on powder bed 14. In cases where it is desired to rotate the pattern of light through an angle about the center of phase modulator 16C that is a multiple of 90 degrees (i.e. the angle is equal to nπ/2 radians, where n is an integer), or it is desired to create a pattern of light that is a mirror image of a current pattern of light, then instead of calculating a new phase pattern corresponding to the rotated or mirror image pattern of light, the phase pattern may be vertically and/or horizontally flipped on phase modulator 16C. The light steering may steer light away from certain areas within the two dimensional region to form low intensity portions of the pattern and to be concentrated at certain other areas within the two dimensional region to form high intensity portions of the pattern. The light steering is a result of interference between the phase shifted light leaving different pixels of phase modulator 16C. Amplitude modulation which operates by selectively attenuating different portions of a usually uniform beam (e.g. by controlling transmissivity of pixels) is not “light steering”.

In some embodiments light that has been steered by a phase modulator 16C is further modulated by an amplitude modulator (not shown). The amplitude modulator may refine the pattern of light produced by phase modulator 16C, for example, to straighten edges, to sharpen edges, remove high intensity artifacts, and otherwise adjust the pattern of light to compensate for deviations from the ideal pattern of light as intended to be produced by phase modulator 16C. The amplitude modulator may be designed to modulate light having high optical power levels. The amplitude modulator may, for example, comprise a liquid crystal based spatial amplitude modulator.

FIG. 1B shows an example pattern 19 for a layer of powder bed 14. The dark portions 19A of pattern 19 indicate areas where the layer of powder bed 14 should be made solid. The light portions 19B of pattern 19 indicate areas where the layer of powder bed 14 should not be made solid. Phase modulator 16C may be controlled to provide a phase pattern which steers light from laser 16A so that energy from the light is concentrated in areas of powder bed 14 that correspond to portions 19A and steered away from areas of powder bed 14 that correspond to portions 19B.

An advantage of apparatus 10 as compared to conventional apparatus in which a laser spot is scanned over a powder bed is that a system 10 may be scaled up to simultaneously pattern a larger area of powder bed 14 and/or more rapidly solidify areas of powder bed 14 that correspond to portions 19A of pattern 19 by increasing the power of laser 16A.

Apparatus like apparatus 10 may be controlled to operate in a large number of ways. These include, for example:
setting phase modulator 16C with a phase pattern that concentrates light from laser 16A on areas of powder bed 14 that correspond to portions 19A and steers light away from areas of powder bed 14 that correspond to portions 19B and solidifying the areas of powder bed 14 that correspond to portions 19A by operating laser 16A. Laser 16A may be operated continuously and/or in pulses until the areas of powder bed 14 that correspond to portions 19A are heated sufficiently to sinter or melt the particles of powder bed 14.
setting phase modulator 16C with a phase pattern that concentrates light from laser 16A on selected zones within areas (a zone is a subsection of an area) of powder bed 14 that correspond to portions 19A and steers light away from areas of powder bed 14 that correspond to portions 19B and solidifying powder bed 14 within the selected zones of powder bed 14 by operating laser 16A. These steps may be repeated for other zones within the areas of powder bed 14 that correspond to portions 19A until all of the areas of powder bed 14 that correspond to portions 19A have been solidified. In solidifying each zone of powder bed 14 that corresponds to each portion 19A of pattern 19, laser 16A may be operated continuously and/or in pulses until the particles of powder bed 14 in the respective zone are heated sufficiently to sinter or melt the particles of powder of powder bed 14.
setting phase modulator 16C with a phase pattern that concentrates light from laser 16A into a given shape (e.g. a circle, line, square, rectangle, obround, oval or the like) within an area of powder bed 14 that corresponds to a portion 19A and modifying the setting of phase modulator 16C to cause the shape in which the light is concentrated to scan in a direction across powder bed 14 to expose more of the area corresponding to the portion 19A. The modification of the phase modulator setting may comprise superposing a wedge with a variable wedge angle onto an initial phase pattern. The modification may be made essentially continuously or made in steps. Laser 16A may be operated continuously and/or in pulses and/or may be briefly turned off or reduced in power when the phase pattern is being modified to move the shape into which the light is concentrated.
performing any of the above separately for different areas of powder bed 14.

Lines 20 in FIG. 1B illustrate one way to divide powder bed 14 into a number of areas 20A (in this example, nine areas 20A). Any of the above operations may be performed separately for each of areas 20A. There may be more or fewer than nine areas 20A. Areas 20A may or may not overlap. Areas 20A do not need to cover all of powder bed 14. It is only necessary that areas 20A collectively cover all areas of powder bed 14 that correspond to portions 19A of pattern 19.

Light steered by phase modulator 16C may, for example, be directed to a corresponding one of areas 20A by any of:
directing the light to a desired one of areas 20A using a scanner;
applying a phase pattern to phase modulator 16C that steers the light to a desired one of areas 20A;
using a one or two dimensional positioner (e.g. an XY positioner) to position part or all of exposure system 16 to direct light to the desired area 20A;
providing plural exposure systems 16 and using different ones of the exposure systems 16 to expose different ones of areas 20A;
combinations of any of the above.

Apparatus 10 may be varied in many ways. These include:
An exposure system 16 may include plural phase modulators 16C that operate in parallel. This construction may extend the mean time between failure of phase modulators 16C and/or simplify thermal management of phase modulators 16C, especially when laser 16A is a high power laser. In such embodiments, different phase modulators 16C may be controlled to have the same or different phase patterns.
A controller for an exposure system 16 may be configured to dynamically vary a phase pattern of phase modulator 16C. For example, the controller may be configured to apply a first phase pattern that provides defocused or uniform illumination of an area of powder bed 14 and a second phase pattern that provides focused illumination of one or more areas of powder bed 14 that correspond to portions 19A. The second phase pattern may, for example, focus light to one or more spots of shapes that lie within or cover all of one of the areas of powder bed 14 that correspond to a portion 19A of pattern 19. The first phase pattern may be applied to preheat all of or a selected area within powder bed 14. The second phase pattern may be applied to solidify areas of powder bed 14 corresponding to portions 19A of pattern 19.
An exposure system 16 may project a combination of steered light and unsteered light. The unsteered light may serve to add heat to powder bed 14 without raising a temperature of powder bed 14 sufficiently to cause the powder of powder bed 14 to solidify. The steered light may increase the temperature within points, shapes or areas of powder bed 14 which correspond to portions 19A sufficiently to cause the powder at locations to which the steered light is directed to solidify. The unsteered light may globally preheat powder bed 14. Such preheating may result in improved efficiency and/or increased melt pool stability and part quality.
The unsteered light may be contributed to by one or more of: light from a light source separate from laser 16A (e.g. an additional laser); light that is specularly reflected by phase modulator 16C; and light that is split from laser beam 16B by a beam splitter. In some embodiments the relative amounts of steered and unsteered light are controlled by a controller.
   One or more heaters may be arranged to preheat powder bed 14.
   Examples of these variations are described below.

In some embodiments which provide heaters for heating powder bed 14, the heaters may be of any known type. In some embodiments the heaters include one of or any combination of two or more of:
one or more light sources configured to direct optical energy onto powder bed 14;
one or more resistive heater elements;
one or more sources of microwave energy;
one or more inductive heaters;
one or more susceptors in combination with a source of radiofrequency or microwave energy.

A susceptor is a device that couples electromagnetic radiation from a source of electromagnetic radiation (e.g. radio frequency or microwave radiation) with a material that does not couple well to the electromagnetic radiation. The susceptor may be applied to heat material of powder bed 14. Some materials that may be used for powder bed 14 may couple stably to electromagnetic energy when the materials are heated to an elevated temperature. In such cases a susceptor may be used to heat the material of powder bed 14 to a temperature at which the heated material couples stably to the electromagnetic radiation from the source of electromagnetic radiation. The source of electromagnetic radiation may then be operated to further heat powder bed 14 by direct absorption of energy from the electromagnetic radiation. The susceptor may, for example supply energy to powder bed 14 by thermal conduction or radiation. A susceptor is described for example in: Buls, S. et al., Microwave Assisted Selective Laser Melting of Technical Ceramics, Proceedings of: Solid Freeform Fabrication Symposium, Austin, Texas USA, August 2018.

In some embodiments, apparatus as described herein includes heaters (e.g. susceptors, sources of optical radiation) capable of heating powder bed 14 to a higher temperature than could practically be achieved using resistance heaters.

The rates at which temperatures change during powder bed fusion, especially after material of the powder bed is melted, can have significant effects on the properties of the resulting parts. For example, the microstructure of some metals can be very different depending upon how quickly the metals are allowed to cool after having been melted. The microstructure can affect important properties such as hardness, abrasion resistance, toughness, etc.

The apparatus and methods described herein may advantageously be applied to control the properties of solidified material of powder bed 14 by one or more of:
controlling the application of energy to solidify powder bed 14;
controlling the rate of change of temperatures of powder bed 14; and
controlling the material composition of powder bed 14.

Tools for such control may include:
preheating powder bed 14 by any of or any combination of: heaters; unsteered light; steered light from an exposure system 16; and scanned light (which may include dynamic beam shaping as described herein). Preheating can affect the amount of heat stored in powder bed 14 which, in turn, affects the amount of additional energy required to solidify powder bed 14 by sintering or melting at any location as well as the rate of cooling after solidification by sintering or melting.
Post-heating powder bed 14 after solidification of locations in powder bed 14 by any of or any combination of: heaters; unsteered light; steered light from an exposure system 16; and scanned light (which may include dynamic beam shaping as described herein). Post-heating can slow the rate of cooling of solidified regions of powder bed 14.
Controlling the application of energy used to solidify areas of powder bed 14. The energy applied to solidify areas of powder bed 14 can increase the overall temperature of powder bed 14. In some cases this energy alone may raise the temperature of powder bed 14 by over 100 C while a part is being made. In some embodiments, preheating and post-heating energy inputs may be adjusted to take into account the energy supplied to pattern solid areas of powder bed 14. In some embodiments a sequence is designed so that energy used to solidify one area of powder bed 14 may provide pre-heating and/or post-heating for one or more adjacent areas of powder bed 14. For example, the methods and apparatus as described herein may be applied to deliver energy to solidify a location on powder bed 14 and simultaneously distribute some energy to one or more areas adjacent to the location for pre-heating or post-heating.
Chilling a surface of powder bed 14 by a (relatively) cold gas. Chilling can increase a rate of cooling of solidified regions of powder bed 14.
Modifying the composition of powder bed 14 at selected locations. The methods described herein may be applied to vary the application of energy in a way that is optimized for different material compositions at different locations in powder bed 14.

Preheating and post-heating can each be performed on one or both of a large scale (e.g. heating the entire powder bed 14 or a macro sized region of powder bed 14 by use of heaters, unsteered light and/or steered light) and a small or micro scale (e.g. heating a very small region using scanned light).

In some embodiments the entire powder bed 14 is preheated to a temperature in excess of 100 C (e.g. 150 C or higher). Such preheating may reduce rapid post solidification cool down. Reducing the rate of cooling can allow the microstructure of the solidified material to grow/alter. For many materials and in many applications such growth/alteration as the solidified material cools more slowly improves the quality of the solidified material.

Varying the composition of powder bed 14 may be achieved by changing composition of a powder of powder bed 14 at selected locations (e.g. varying a ratio of metallic elements present at different parts of powder bed 14) and/or by solidifying selected locations of powder bed 14 in the presence of a reactive gas that affects the composition of the solidified material at the selected locations.

A part may be made using the apparatus described above by successively solidifying layers of powder bed 14. Patterns 19 which correspond to each layer of powder bed 14 specify what areas within that layer are to be solidified to yield the desired part.

In some embodiments the exposure for each layer is controlled using real-time process feedback. For example, a sensor such as a camera and/or a thermal imager may be positioned to monitor powder bed 14. Because the emissivity of different material phases that may be present in powder bed 14 (e.g. powder, solid, liquid) can vary dramatically it can be difficult to determine temperature by monitoring infrared light emitted by the powder bed. However, direct temperature measurements are not required for feedback signals. In some embodiments laser light reflected from powder bed 14 and/or thermal emissions from powder bed 14 and one or more infrared or optical wavelengths are used as feedback signals. For example, feedback control may be based at least in part on the intensity and wavelength of light emitted from a melt pool.

The feedback control may be applied to ensure that the exposure for the current layer solidifies the areas of the current layer specified by the layer data and does not solidify areas of the current layer that should not be solidified according to the layer data for the current layer.

In some embodiments, examples of feedback control include:
Exposure may be continued until the sensor indicates that the powder bed has solidified in the areas specified by the layer data.
Determining that the powder has solidified by one or more methods. For example by determining that a temperature of the powder is higher than a threshold and/or confirming by image analysis that the powder bed has melted in the appropriate areas of powder bed 14.
Adjusting exposure to prevent solidifying areas of the current layer of powder bed 14 that should not be solidified according to the layer data for the current layer. The adjustment may include one or more of:
   changing the power of the light used for the exposure;
   changing the phase pattern to reduce the optical power directed to areas of the powder bed that should not be solidified if those areas have a temperature that exceeds a threshold (for example, by adjusting the phase modulator to defocus light incident on an area of powder bed 14);
   interrupting the exposure; and/or
   changing a setting of a heater such as, for example, an unsteered light beam that illuminates powder bed 14.

In some embodiments feedback control includes controlling the temperature of those areas of powder bed 14 that are to be solidified in the current layer and controlling the temperature of those areas of powder bed 14 that are not to be solidified in the current layer. Temperature of these areas may be controlled in the same or separate feedback loops.

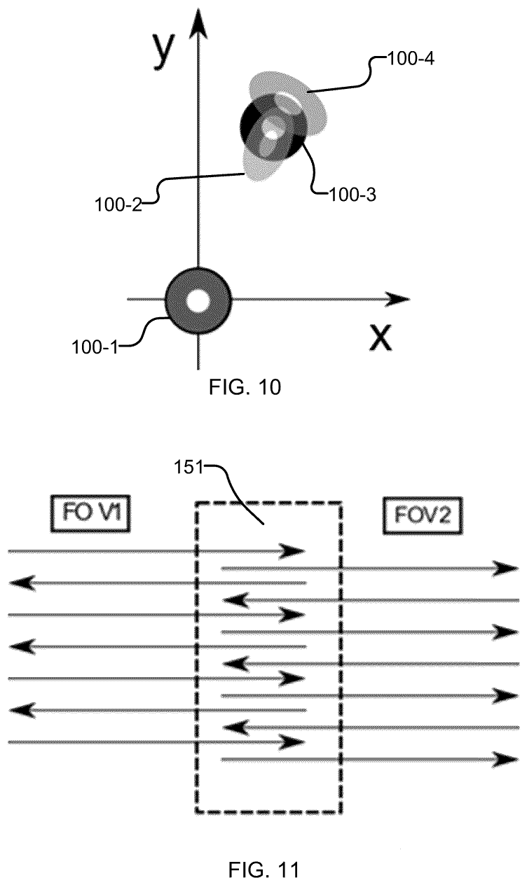

FIG. 10 shows apparatus 10-1 according to another embodiment that is similar to apparatus 10 but includes plural exposure units 16. Exposure units 16 may operate in parallel. Different arrangements of exposure units 16 are possible. For example:
two or more or all of exposure units 16 of apparatus 10-1 may illuminate the same area of powder bed 14;
two or more of exposure units 16 of apparatus 10-1 may illuminate overlapping areas of powder bed 14;
each of exposure units 16 of apparatus 10-1 may illuminate a distinct area of powder bed 14;
some of exposure units 16 of apparatus 10-1 may deliver unsteered light and/or defocused steered light. Output of such exposure units 16 may be controlled to heat powder bed 14;
different ones of exposure units 16 may be operated to illuminate corresponding areas of powder bed 14 (which may be distinct and/or may overlap) simultaneously and/or in a prescribed sequence.

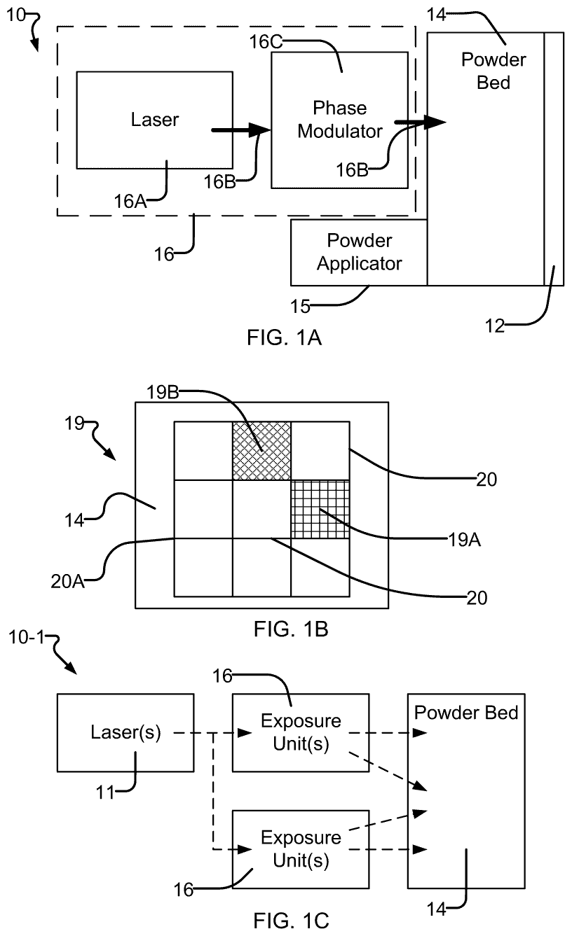

FIG. 2 illustrates an example exposure system 16-1. Exposure system 16-1 includes two phase modulators 160-1 and 16C-2 that operate in parallel. Light from a laser 16A emits a laser beam 16B (see FIG. 1A). Laser beam 16B passes through a beam shaping unit 16D. Beam shaping unit 16D collimates laser beam 16B to yield a conditioned output beam 16B-1. For example, if laser beam 16B is diverging as is typical for laser beams emitted by fiber lasers, optical elements of beam shaping unit 16D may remove the divergence.

Beam shaping unit 16D includes optical elements that expand and shape laser beam 16B to match or nearly match the size and shapes of active areas of phase modulators 160-1 and 16C-2. For example, conditioned beam 16B-1 may have a rectangular or elliptical cross-sectional profile selected to fill the active areas of phase modulators 160-1 and 16C-2 without excessive loss of light. In an example embodiment beam 16B-1 has a rectangular cross section having a form factor (ratio of height to width) that matches that of active areas of phase modulators 160-1 and 16C-2 and a size that matches or is slightly larger than the active areas of phase modulators 16C-1 and 16C-2.

The distribution of energy in beam 16B-1 may be generally uniform over the cross sectional area of beam 16B-1. Precise uniformity is not required because deviations from uniformity that would affect performance may be compensated for by phase modulators 16C. The output from beam shaping unit 16D is collimated light beam 16B-1.

Beam 16B-1 is split into two beams 17-1 and 17-2 by optical power divider 16E. Power divider 16E may, for example, comprise a polarizing beam splitter. Beams 17-1 and 17-2 may carry equal optical power. Beams 17-1 and 17-2 respectively illuminate active areas of phase modulators 16C-1 and 16C-2.

In a variation of exposure system 16-1 beams 17-1 and 17-2 are generated by separate lasers. The two lasers may be polarized lasers that emit polarized beams 17-1 and 17-2. The polarization of each of beams 17-1 and 17-2 may be matched to the corresponding phase modulator 16-1 or 16-2.

Phase modulators 16C-1 and 16C-2 are controlled to present phase patterns that steer the light of beams 17-1 and 17-2. In some embodiments the same phase pattern is applied to both of phase modulators 16C-1 and 16C-2. In some embodiments different phase patterns are applied to phase modulators 16C-1 and 16C-2.

After interacting with phase modulators 16C-1 and 16C-2 beams 17-1 and 17-2 are combined at beam combiner 16F to yield a combined beam 17-3. Beam combiner 16F may, for example, comprise a polarizing beam splitter.

Where power divider 16E is a polarizing beam splitter, beams 17-1 and 17-2 have different polarizations. In the illustrated embodiment beam 17-1 passes through a first wave plate 16G which alters the polarization of beam 17-1 to match a polarization required by phase modulator 16C-1. For example, beam 17-1 may initially be linearly polarized and may have a polarization that is at 90 degrees to a polarization of phase modulator 16C-1 and first wave plate 16G may be a half wave retarder oriented to rotate the polarization of beam 17-1 by 90 degrees to match phase modulator 16C-1.

Where beam combiner 16F is a polarizing beam splitter it is desirable that beams 17-1 and 17-2 have orthogonal polarization states where they enter beam combiner 16F. In the example case where beams 17-1 and 17-2 are linearly polarized this may be achieved by passing one of beams 17-1 and 17-2 through a second wave plate 16H. For example, second wave plate 16H may be a half wave retarder oriented to rotate the polarization of a beam 17-1 or 17-2 by 90 degrees. In the illustrated embodiment, second wave plate 16H is in the optical path of beam 17-2 after phase modulator 16C-2. Putting first phase plate 16G in one of beams 17-1 and 17-2 and putting second phase plate 16H in the other one of beams 17-1 and 17-2 balances the effect on beams 17-1 and 17-2 of any attenuation provided by phase plates 16G and 16H.

The resulting combined beam 17-3 is directed to a folding unit 16J which redirects combined beam 17-3 onto a powder bed 14 (not shown in FIG. 2). Folding unit 16J optionally includes optical elements that help to focus the steered light of combined beam 17-3 onto a corresponding area of powder bed 14.

Exposure system 16-1 includes optional mirrors 16K which fold the paths of the described light beams to make apparatus 16-1 more compact.

Exposure system 16-1 may provide advantages such as one or more of:
Each of phase modulators 16C-1 and 16C-2 modulates a corresponding beam 17-1 or 17-2 which has significantly lower power than the combined beam 17-3. This opens the possibilities of using a higher powered laser 16A and/or using phase modulators 16C that have lower power ratings. This may also improve the expected useful lifetimes of phase modulators 16C.
Providing two or more phase modulators 16C may facilitate smooth updates of a projected pattern of light and/or more detailed patterns of light since the plural phase modulators 16C-1 and 16C-2 may be updated at different times and/or the plural phase modulators may be controlled to display different phase patterns.
Cost of apparatus 16-1 may be lower than a comparable apparatus that uses more lasers to achieve the same optical power.

Exposure system 16-1 may be modified in various ways including:
Separate lasers may be provided to illuminate different phase modulators (e.g. 16C-1 and 16C-2);
A simpler version of exposure system 16-1 has a single laser that illuminates a single phase modulator;
An exposure system may include more than two phase modulators 16C (which may be illuminated by one or two or more lasers);
Available optical power may be increased by providing multiple polarized lasers that each illuminate one or more phase modulators operable to steer light onto a powder bed (a suitably oriented polarizing beam splitter may divide a laser beam output by a polarized laser into two beams). In some embodiments light steered by two or more phase modulators is combined to illuminate an area of a powder bed. In some embodiments the number of such lasers that is operated at any time is controlled to match a demand for optical power on a powder bed;
Folding unit 16J may comprise or be associated with a scanner that shifts the location of a pattern of light projected from folding unit 16J onto powder bed 14;
Instead of being combined into a combined beam 17-3, light beams 17-1 and 17-2 may be directed to different folding units 16J which may direct light onto different areas of powder bed 14; and/or
power divider 16E may be variable to allow the relative power of beams 17-1 and 17-2 to be adjusted.

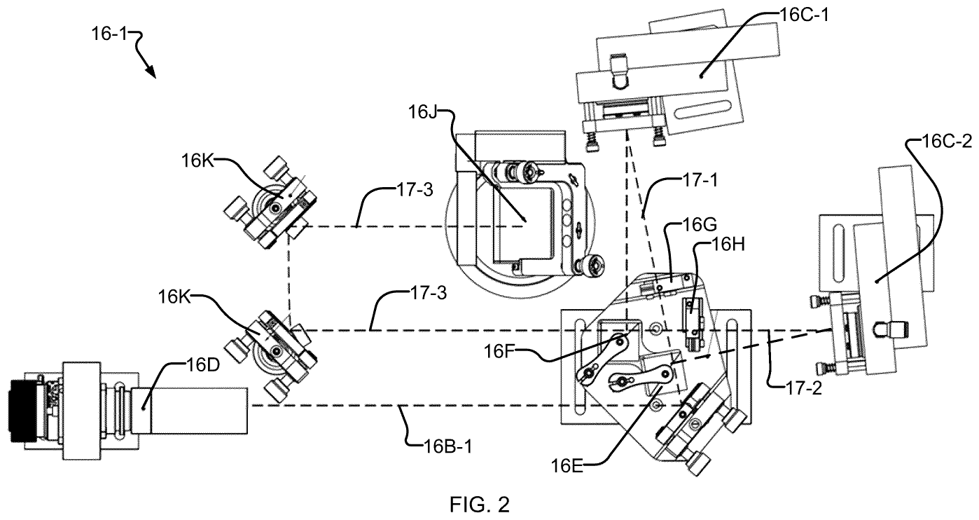

FIG. 3 is a perspective view showing an optical splitter/combiner assembly 30 as used in exposure system 16-1 of FIG. 2. Assembly 30 includes deflection mirror 16K, optical power divider 16E which may be a polarizing beam splitter, optical combiner 16F, which may be a second polarizing beam splitter, first wave plate 16G and second wave plate 16H.

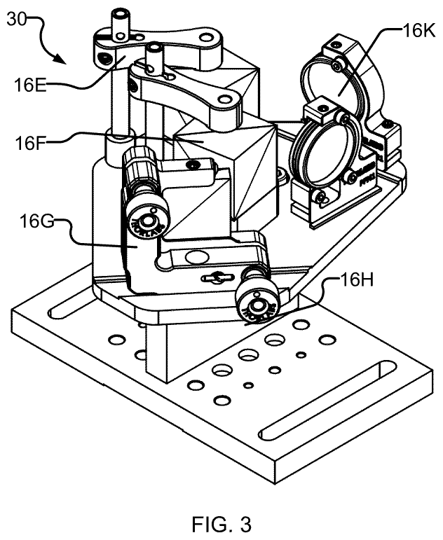

FIG. 4A schematically illustrates an example beam shaping unit 40 of a type which may, for example, be used for beam shaping unit 16D in exposure system 16-1 of FIG. 2. Beam shaping unit 40 includes fiber laser connector 42 which receives incident beam 16-B, telescopic lens tube 44, and fine-telescopic lens tube 46. FIG. 4B is a cross-sectional view of beam shaping unit 40. Fast axis collimation lens set 47 is enclosed within telescopic lens tube 44 and slow axis collimation lens set 49 is enclosed within fine-telescopic lens tube 46.

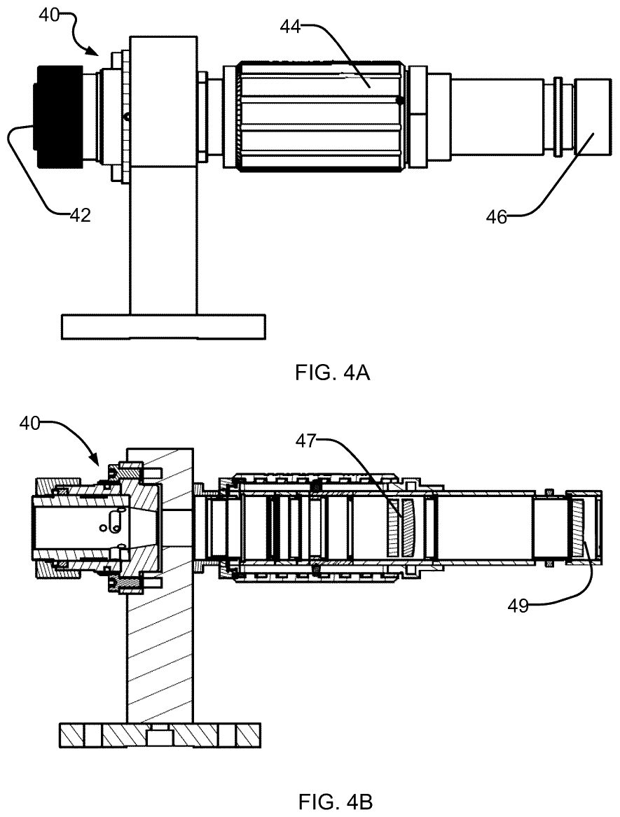

FIGS. 5A and 5B show a phase modulator 16C supported by an example mounting bracket 50. Phase modulator 16C is in thermal contact with a cooled block 52 that is in turn connected to a heat spreader 54. Heat is removed from cooled block 52, for example, by a Peltier cooler 56. Heat is removed from Peltier cooler 56 by water flowing in cooling passages inside bracket 50 that are in thermal contact with heat spreader 54.

An aperture 58 is spaced apart from phase modulator 16C. Aperture 58 is sized to pass a light beam that is incident on an active area of phase modulator 16C and an outgoing light beam that has been phase modulated by phase modulator 16C. In some embodiments the position and/or orientation of aperture 58 relative to the active area of phase modulator 16C may be adjusted to admit a light beam that fully illuminates an active area of phase modulator 16C while blocking light that would fall outside of the active area of phase modulator 16C. Adjustment of aperture 58 and/or compression of phase modulator 16C may, for example be adjusted by one or more adjustment screws such as adjustment screws 59. In the embodiment shown in FIG. 5B springs 59A accommodate thermal expansion of phase modulator 16C.

In the FIG. 5A embodiment, a controller 55 that comprises electronics for driving phase modulator 16C to present different phase patterns is supported on bracket 50.

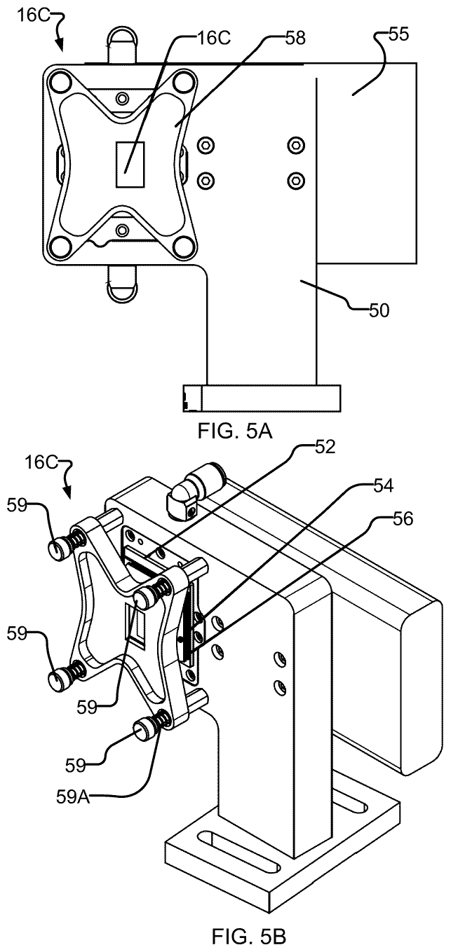

FIG. 6 illustrates an example folding unit 16J. In this example, folding unit 16J includes a mirror 61 that is angled (in this example at 45 degrees) to redirect combined beam 17-3 onto powder bed 14. In this example, folding unit 16J also includes a plurality of focusing optics 62 (which may for example comprise lenses) that assist in focusing the steered light onto the top layer of powder bed 14.

In FIG. 6, mirror 61 directs steered light to be incident more or less perpendicularly to powder bed 14. In some embodiments steered light is directed obliquely onto powder bed 14. Such embodiments may, for example, allow illumination of powder bed 14 without needing any optics directly above powder bed 14. In such embodiments light incident on different parts of an area illuminated by beam 17-3 may be incident on powder bed 14 at different oblique angles.

In such embodiments, focus may be maintained over the surface of powder bed 14 by adjusting the phase pattern applied by a phase modulator 16C and/or providing an aspherical optical system. For example, one or more phase modulators may be controlled to include a phase component that acts as a f-theta lens which provides a focal length (f) that is a function of the oblique angle (theta). The phase patterns may additionally compensate for geometric distortions resulting from the oblique angles of incidence of combined beam 17-3 on powder bed 14 as described elsewhere herein.

The desired focal length (f) for illuminating a particular point on powder bed 14 will depend on the height of powder bed 14 relative to the rest of the apparatus. Consequently, it is generally necessary to perform an initial calibration of the apparatus to establish good focus on the top of powder bed 14.

In some embodiments apparatus as described herein is configured to ‘auto-focus’ a light beam onto powder bed 14. Auto focus may be performed by using a camera system (e.g. an on-axis camera system) to monitor a size of a spot of light on powder bed 14 that should be focused onto powder bed 14. Auto focus may be achieved by adjusting a phase pattern applied to a phase modulator to provide a focal length appropriate for optimum focus of the spot of light. For example, auto focus may be achieved using an iterative process in which the camera is operated to obtain an image of the spot of light on powder bed 14, the image is processed to determine a size of the spot of light, a component of a phase pattern provided by the phase modulator is modified in a way that may improve the spot size. This iterative process may be repeated until a size of the spot of light satisfies a criterion (e.g. the spot of light has a diameter less than some threshold) or a phase pattern which minimizes the size of the spot of light has been found or a desired number of iterations has been completed.

In some embodiments the phase pattern component that is optimized by this process is a parameterized lens model. The lens model may include one or more parameters. Optimization may be performed over the parameter space of the lens model. For example, the lens model may include a focal length parameter. When parameter value(s) for the lens model are supplied the lens model may output a corresponding set of phase delays for pixels of the phase modulator. This set of phase delays may be applied to the phase modulator to focus the spot onto powder bed 14.

In addition or in the alternative to auto focusing by adjusting a phase pattern applied by a phase modulator as described above, auto focusing may be performed by physically moving the scanner that delivers the spot of light relative to powder bed 14 (e.g. by operating an actuator connected to move the scanner toward or away from powder bed 14) and/or by operating an actuator to adjust a physical focusing element in an optical path of the light beam that provides the spot of light.

Since thermal lensing causes a change in focus, a process like the auto focus method described above may be used to compensate for the effects of thermal lensing. In some embodiments a controller establishes corrective phase patterns for compensating for thermal lensing for different temperatures of components of the apparatus as described herein and/or different optical power levels using techniques as described herein and subsequently applies the corrective phase patterns to a phase modulator based on one or more measured component temperatures and/or a current optical power level to correct for thermal lensing.

### 2: Dynamic Shaping/Profiling of Scanned Beams

Another aspect of the present technology provides dynamic shaping and/or profiling of scanned light beams (“DBS”). DBS may be applied to provide different beam shapes and/or different beam energy density distributions for different areas of a layer of powder bed 14 or even for different sections of the same scan line. The light beams may, for example, be steered by a scanner (for example a scanner that includes galvano mirrors). In some embodiments the scanner includes one or more rotating polygon mirrors which redirect light beams from pulsed laser light sources. As described in more detail elsewhere herein, dynamic shaping and/or profiling of scanned beams may be applied together with or separate from a system that illuminates 2D regions with steered light.

DBS may be applied to alter the size, shape and/or energy distribution of a scanned beam in real time. The scanned beam may be focused to a small spot. The minimum achievable size of the spot depends on the wavelength of light in the scanned beam (e.g. the minimum possible spot size is diffraction limited). A smaller spot size may be achieved by using light that has shorter wavelength(s). Other factors that can affect the minimum achievable spot size include the quality of the light beam(s) generated by the system, the spatial and phase resolutions of phase modulator(s) used to implement DBS, and the quality of optical components.

The size of a scanned spot that is optimum for any specific scenario can depend on factors such as:
parameters of the scanner that is directing the optical radiation (e.g. what is the hatch spacing between adjacent scan lines);
power requirements (smaller spots may provide higher energy densities than larger spots in which the same optical energy is distributed over a larger area);
speed requirements (in some cases, a larger spot size may facilitate solidifying a given area of a powder bed 14 in a shorter time than a smaller spot size).

For example, in some applications the spot may fit within a circle on the order of 60 μm in diameter (e.g. 20 to 150 μm in diameter) or the spot may have a smallest transverse dimension on the order of 60 μm. Such small spots may be used to accurately render small solidified features in powder bed 14.

Advantageously, DBS can be applied to dynamically vary spot size to optimize creation of different features of a part.

In some embodiments DBS is controlled based on the configuration of areas in a current layer of powder bed 14 to be solidified. For example, DBS may be controlled to use different beam shapes, beam sizes and/or beam power distributions based on factors such as one or more of:
how close is the point currently illuminated by the beam to an edge of a solid area 19A;
how small are the features of the part being made near the point currently illuminated by the beam;
how high are the standards for surface finish, material properties etc. of the part currently being made;
is the beam approaching a boundary between an area of the powder bed that should be solidified and an area of the powder bed that should not be solidified;
how tight is a dimensional tolerance in the portion of the part being made at the current position of the point illuminated by the beam;
how recently were other points scanned that are adjacent to the point currently illuminated by the beam;
properties of the material of the powder bed such as: sintering temperature, melting temperature, heat capacity, thermal conductivity, melt pool viscosity, particle size, layer thickness, etc.;
how fast is the beam being scanned;
if the beam is being scanned along a curved trajectory, what is the radius of the curve;
desired post-fusion profile of temperature vs. time;
part quality requirements e.g. required surface finish.

In some embodiments, layer data that indicates which areas of the current layer of powder bed 14 are to be solidified is processed to determine a path for scanning a beam and/or to determine DBS parameters for different points along the path for scanning the beam. The DBS parameters may include, for example, one or more of:
beam intensity;
beam spot size;
beam power density profile;
beam shape;
behavior of a dynamic beam component; and/or orientation of the beam profile relative to the scanning direction.

In some embodiments, DBS parameters are generated with reference to known “process windows” for material(s) of powder bed 14. A process window is a set of ranges for different beam parameters within which the material(s) behave acceptably. The parameters may, for example, include beam energy density, beam scanning speed, and powder bed temperature. Unacceptable results such as defects caused by lack of fusion, balling, key-hole formation and other melt pool instabilities may occur where the beam parameters being used are outside of a process window.

Process windows that include DBS parameters may facilitate improved performance. For example by selecting suitable DBS parameters one may achieve faster scanning speeds (and therefore reduced processing time) within a process window which provides a desired quality level of finished parts and/or one may achieve improved microstructure of solidified parts of powder bed 14 (in some embodiments without compromising processing speed) and/or one may use a lower grade (e.g. coarser) powder for powder bed 14 without compromising part quality. DBS can have a pronounced effect on the thermal history of solidified portions of powder bed 14 and thus on the microstructure/part-quality.

In some embodiments DBS parameters are generated by an automated control system. The automated control system may include stored data (“process window data”) that defines process windows for the material(s) of powder bed 14. The process window data may, for example, define process windows for plural materials. For some materials the process window data may define plural process windows. In some cases the different process windows for a particular material may correspond to different characteristics of the material, when solidified (e.g. different desired microstructures, different surface textures, etc.). DBS parameters may be included in the process window definitions. The automated control system may select DBS and other parameters from the available defined process windows. These parameters may be dynamically varied to optimize in desired ways such as:
minimizing the time to make a part;
maximizing a quality of the part;
providing specified material qualities at specified locations of the part;
providing accurate control over certain dimensions of the part (and possibly maintaining looser tolerances for other dimensions);
etc.
   The control system may execute a control algorithm that sets process parameters (e.g. beam shape and size, power intensity distribution in the beam, overall power of the beam, scanning speed, scanning pattern, hatch distance, layer thickness, etc.).

DBS may be combined with feedback control. The feedback control may alter default or previously determined DBS parameters based on one or more feedback signals. The feedback control may, for example, be based at least in part on feedback signals as described above in relation to control of broad area illumination. Feedback signals may, for example, be obtained by:
Thermal imaging of all or a part of powder bed 14 (e.g. using an infrared camera or a thermal imager);
High resolution optical imaging on all or part of powder bed 14;
Temperature sensors (e.g. thermocouples and/or thermistors) located to sense temperatures around the periphery of powder bed 14 or at specific locations in or around powder bed 14;
Analysis of process light (i.e. light emitted from the melt pool and/or from a plasma cloud over the melt pool). The analysis may take into account either or both of intensity and wavelength spectrum of the process light. Such light may, for example, be collected in the optical path of a scanner that directs a beam of light to solidify powder bed 14 or using a separate scanner that is controlled to track the location of the melt pool and/or by tracking the location of the melt pool in images of powder bed 14 acquired by a high resolution camera system;
An acoustic or vibration sensor operable to sense sounds or vibrations resulting from melt pool instabilities;
Mechanical probing of the surface of solidified portions of powder bed 14.

Feedback may be based on properties of a previous layer. For example, a camera may monitor powder bed 14 for defects. An example defect may occur when a section of a previous layer has become distorted (e.g. by starting to curl up). When such a defect is detected, a controller may alter scanning patterns for one or more subsequent layers. For example, the scanning pattern may be altered to ‘skip’ an area corresponding to the distorted section and/or alter scanning of the area corresponding to the distorted section so that the distortion does not propagate further. In at least some cases this approach may mitigate the distortion without halting the process of making a part. As additional layers are added to the powder bed the area affected by the defect may decrease to a point that normal scanning may be resumed in the area corresponding to the defect.

In some embodiments a control system compensates for changes in steering efficiency of a phase modulator (which may occur, for example, as a result of changes in temperature of the phase modulator). Control signals applied to a phase modulator with the intention of steering light to form a particular light field (e.g. a particular distribution of optical energy provided by a beam shaped by DBS or an exposure unit as described herein on powder bed 14) may be adjusted to compensate for changes in light steering efficiency by measuring a distribution of optical energy in a light field steered by the phase modulator and adjusting the control signals to compensate for differences between the actual and desired light field. This control may be done occasionally, for example by feed forward control and/or may be performed continuously in a feedback loop. Such control may compensate for some misalignments of optical components (which may, for example, result from mechanical disturbance or temperature effects) and/or changes in the properties of a phase modulator (e.g. due to temperature changes).

DBS may be controlled to use different beam shapes and/or beam power distributions and/or beam power based on factors such as:
if the point on powder bed 14 that is currently being scanned corresponds to a point at which the current layer of powder bed 14 should be solidified, how far is the temperature of the current point below a target temperature for solidifying the powder bed;
based on measured temperatures of points on powder bed 14 adjacent to the point that is currently being scanned and a model of heat flow in powder bed 14, how much energy is required to solidify powder bed 14 at the point currently being scanned.

Examples of the kind of control that may be implemented by DBS include:
reshaping the beam;
changing an energy density profile of the beam (e.g. to add or remove energy from a section of the beam such as a ‘hole’ of a ‘donut’ beam profile);
focusing or defocusing the beam;
temporarily dumping energy from all or a section of the beam (e.g. by configuring a phase modulator to redirect some light to a beam dump);
pulsating the energy from all or a section of the beam.

Scan patterns may be controlled together with DBS. For example, scan patterns may include patterns that are:
uni-directional (e.g. parallel scan lines along which light spots are scanned in the same direction);
bi-directional or “zig-zag” (e.g. parallel scan lines along which light spots are scanned in opposite directions in alternating scan lines);
island patterns (e.g. patterns in which a light spot is scanned over an island which occupies less than all of an area of powder bed 14 that can be addressed by a scanner);
exclusion patterns (e.g. scan patterns in which areas of a powder bed 14 that are addressable by a scanner are not scanned).
   In any of these patterns the hatch spacing (distance between adjacent scan tracks) may be varied.

DBS may be controlled in coordination with scan patterns. For example, DBS may be set to control the size, shape and/or energy distribution of a scanned spot based on the scanning pattern and/or scan speed. For example:
For a unidirectional scan pattern, instead of turning off a light source when the scanner is repositioning to the start of the next line, DBS may be used to defocus a light spot to add preheat to power bed 14.
DBS may be used to shape the width of a scanned light spot based on hatch spacing. For example to make the light spot wider when the hatch spacing is increased or to make the light spot narrower when the hatch spacing is decreased.
DBS may be used to adjust a length of a scanned light spot along a scanning direction in response to a scanning speed. For example, to make the light spot longer when scan speed is increased or shorter when scan speed is decreased.
DBS may be used to defocus a scanned light spot inside an exclusion area in an exclusion pattern and/or outside an island in an island pattern.

A control algorithm may have access to and thus control over all process parameters (e.g. beam shape, power intensity throughout the shape, overall power of the beam, scanning speed, scanning pattern hatch distance, layer thickness, etc.).

Appropriate application of DBS may increase additive manufacturing quality by influencing microstructure, increasing melt pool stability and/or reducing the incidence of keyhole pores. The use of DBS may facilitate feature-optimized parameter sets and beam shapes, resulting in powder cost reduction and process speed increase.

In some embodiments a dynamic beam shaping system operates to optimize the spatial energy distribution during an additive manufacturing process without physically adjusting passive optics and/or without limitation to any predetermined combination of beam shape, beam size and spatial energy distributions.

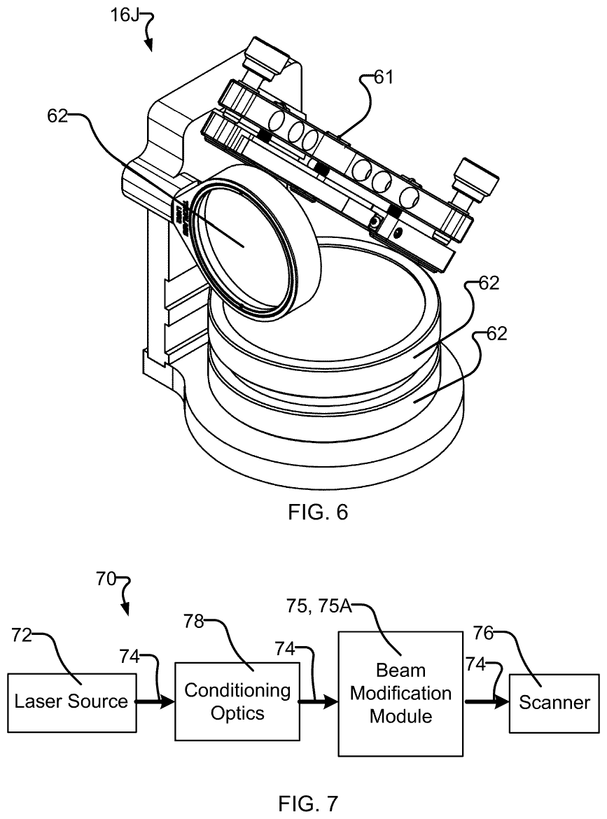

FIG. 7 is a block diagram showing an example apparatus 70 which implements dynamic beam shaping. Apparatus 70 includes a laser light source 72 operative to emit a laser beam 74 into a beam modification module 75.

Beam 74 may have a first spatial energy distribution (e.g. Gaussian). Beam modification module 75 is operable to dynamically alter the shape and/or energy distribution of beam 74. The modified beam 74 is scanned over all or a selected area of powder bed 14 by a scanner 76.

Some examples of the types of modification that beam modification module 75 may be controlled to make to the energy distribution of beam 74 in some embodiments are:
flattening an energy distribution to make the energy distribution more uniform or making the energy distribution more peaked;
making the energy distribution weighted more heavily to one side of the direction of scanning and weighted less heavily to another side of the direction of scanning;
shaping the energy distribution to have a “donut” configuration in which a ring of higher energy density surrounds an area of lower energy density;
shaping the energy distribution to have a cross (X) or plus (+) shaped configuration;
shaping the energy distribution to have a letter V or H-shaped configuration; shaping the energy distribution to be elongated. The elongation may, for example, be in a direction of scanning, perpendicular to the direction of scanning or at some other angle to the direction of scanning;
expanding an area covered by the energy distribution or more tightly focusing the energy distribution; and/or
increasing or reducing energy levels in the energy distribution.

In some embodiments predefined shapes are specified for different applications. For example, different predefined shapes may be specified for different features such as:
thin walls;
sharp corners;
interiors of solid areas;
features requiring enhanced precision;
features requiring particular microstructures;
etc.
   Different shapes may be specified for different materials.

A control system may include shape data that specifies shapes for different features. The control system may process patterns 19 for layers of a part being made to identify features (or combinations of features, materials, specified microstructures and/or specified precision) that lie along different scan lines. The control system may then set beam shapes and/or other beam parameters to use for the parts of each scan line corresponding to the different features. In some embodiments the beam shapes are parameterized by one or more parameters (that may, for example set dimensions or aspect ratios of the beam shapes). In some embodiments the selected beam shapes are adjusted during processing of powder bed 14 based on feedback signals as described herein.

Some examples of the types of modification that beam modification module 75 may be controlled to make to the shape of beam 74 in some embodiments are:
shaping the beam profile to be a desired shape such as a circle, oval, ellipse, obround, rectangle, etc.;
stretching the beam profile in a direction of scanning, perpendicular to the direction of scanning or at some other angle to the direction of scanning;
enlarging or shrinking a boundary of the profile of beam 74; and/or
altering the shape of the beam based on the condition of the surface beneath or the condition of the area next to the scan line currently being processed. For example, in contrast to solidified material, powder has a lower thermal conduction. When processing a scan line next to an already solidified area, the melt pool has a tendency to creep/deform toward the solid material. One could shape the beam to reduce energy density on a side of the beam toward the solid material to counteract this behavior.

Beam modification unit 75 may comprise a spatial light modulator 75A that is dynamically controllable to adjust the shape and/or energy profile of beam 74. In preferred embodiments spatial light modulator 75A comprises a spatial phase modulator and the spatial phase modulator is controlled as described herein to steer light of beam 74 to achieve a desired beam shape and energy density profile at the location where beam 74 illuminates powder bed 14.

Spatial light modulator 75A may be controlled in real time as beam 74 is scanned across powder bed 14 in a raster scan pattern or any other scan pattern. The control may, for example, be based on one or more of:
the speed and/or direction in which beam 74 is being scanned across powder bed 14;
the pattern of solidified areas to be formed in the current layer of powder bed 14;
where beam 74 is currently directed relative to the pattern of solidified areas to be formed in the current layer of powder bed 14;
feedback information such as a current temperature map of powder bed 14 and/or image feedback regarding the presence of any defects in already scanned areas and/or successful solidification in some areas of the top layer of powder bed 14;
the characteristics of the material of powder bed 14;
ambient conditions at powder bed 14.

In some embodiments of apparatuses as described herein that include a spatial phase modulator, the spatial phase modulator may be controlled to provide a phase pattern that simultaneously performs two or more functions. This may be done by applying a phase pattern that is a superposition of two or more phase pattern components. In some embodiments the phase pattern components are separately determined and then combined for application to a phase modulator. The combination may involve, for example, adding corresponding pixel values of the phase components which represent phase shifts. Since most phase modulators can provide phase shifting only within a limited range (e.g. 2π radians) the adding may comprise adding the pixel values of the phase components modulo 2π.

For example, a phase pattern component may comprise:
a component that distributes light to provide a desired pattern of energy density;
a component that selectively focuses or defocuses light at powder bed 14;
a component that compensates for variations in or deviations from ideal of a light beam incident on the phase modulator;
a component that compensates for variations in the performance of and/or defects in the phase modulator;
a component that compensates for a geometry of a scanner;
etc.

A simple example application of DBS is to selectively defocus a laser spot to facilitate increased process speed. Defocusing the laser spot results in a bigger spot-size, which may solidify a larger area of powder bed 14 in one pass. For example, the contour of a part may be processed using a focused/small spot size and while inner dense regions of the part are processed with a defocused larger spot. This technique may be referred to as a ‘skin-core’ scan strategy.

Another example application of DBS is to maintain a desired relative orientation of an energy density distribution of a scanned spot to a scan direction while the scan direction is being changed (e.g. to follow a curved contour of a part). For example, a spot configured to have a V- or H- or I- or A-shaped energy distribution may be controlled so that a symmetry axis of the energy distribution is aligned with a current scanning direction.

Another example application of DBS is to keep a shape of a scanned spot aligned in a desired way with the current direction of scanning along a non-straight path. For example, the orientation of a spot may be rotated as a corner on a scan line is being processed. For example, the spot may have a V-shaped energy distribution and the orientation of the V-shape (or other shape) may be altered as the scan progresses around a corner. As another example, the energy profile of a spot may be changed as the spot is scanned around a corner. For example, the spot may have one shape (e.g. a V-shape) when traversing a first segment of a scan line approaching a corner. Near the corner the spot may be changed to a different shape (e.g. a donut energy profile). After the corner as the spot is scanned away from the corner along a second segment of the scan line the spot may be changed back to a V-shape with an orientation that has a desired relationship to the second segment of the scan line. Changes in orientation of a scanned spot may be abrupt, or progressive.

Some embodiments combine a plurality of scanners with DBS. In such embodiments, DBS may be applied to shape two or more beams to work together. For example, a first scanner may be controlled to cause a corresponding spot to follow the spot of a second scanner. For example, the spots of the respective scanners may be shaped to achieve a desired profile of temperature vs time for each part of the scan line that that the spots pass over. Energy profiles of the spots may be dynamically changed as the spots are scanned.

As another example, a constellation of three or more spots may be scanned along a scan line. The spots may be spaced apart along the scan line, super posed with one another and/or spaced apart in a direction transverse to the scan line. Individual ones of the spots may be controlled by DBS to have beam shapes that collectively provide a desired spatial and temporal thermal profile on the powder bed.

DBS may be used to generate movements and/or intensity changes of the energy distribution of a spot as the spot is scanned. Some examples include:
pulsing the identity of the spot;
moving the spot side-to-side (e.g. in a zigzag pattern) as scanning progresses;
wobbling the spot to follow circles as scanning progresses;
moving the spot forward and backward in the scanning direction (e.g. so that the velocity of the spot in the scanning direction pulsates);
combinations of the above.

In some embodiment these movements and/or intensity changes are accomplished by DBS without altering operation of a scanner.

Where spatial light modulator 75A is a phase modulator, the phase modulator may be controlled to selectively focus or defocus the beam 74 incident on powder bed 14. For example, the phase modulator may be controlled to provide a lens component that acts as a variable focal length lens. Varying the focal length of the lens component allows selective focusing/defocusing to be performed on the fly without moving any physical lenses or other optical components.

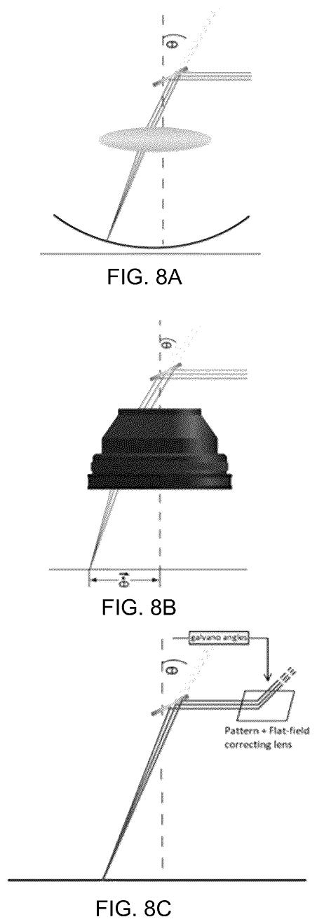

Another example application of DBS is compensating for the fact that where a scanner operates by changing an angle at which a light beam is incident on powder bed 14, the effective distance that the light beam travels to reach powder bed 14 varies with the angle of scan. This is illustrated in FIG. 8A which is a schematic view of a scanner that has a focus lens having a fixed focal length. As the scanning angle, θ, is varied the point at which the light beam is focused follows an arc. Another problem illustrated in FIG. 8A is that, where angle θ changes at a constant rate the speed of the laser spot as it moves over powder bed 14 varies with angle θ.

One way to solve the problems illustrated in FIG. 8B is to use a f-θ (or “f-theta”) lens for a focus lens as illustrated in FIG. 8B. A f-θ lens is shaped with a barrel distortion designed to provide a focal length that varies with the angle from which light is incident on the f-θ lens so that the focus point lies in the same plane regardless of angle θ. A f-θ lens can also cause the changes in angle θ to relate linearly to changes in the location at which the beam hits powder bed 14. f-θ lenses generally do not remove all distortions caused by the scanning geometry.

Another way to solve the problem illustrated in FIG. 8A is to configure a phase modulator with a dynamically varying phase pattern component that simulates the behavior of a flat field lens or a f-θ lens as illustrated in FIG. 8C. This can be done by controlling the phase pattern component to vary with the scanning angle θ so that as θ varies the beam remains focused on powder bed 14.

In an example embodiment different phase components are pre-calculated for different scanning angles and stored. Each stored phase component corresponds to a range of scanning angles (e.g. a range from θ=A to θ=B where A<B or, when there are two scanning angles, θ and ϕ a range from θ=A to θ=B and ϕ=C to ϕ=D where A<B and C<D) and is operative to focus the scanned light beam onto powder bed 14 when the scanning angle(s) is within the corresponding range. A control system for the phase modulator may monitor a signal that indicates the current scanning angle(s) and control the phase modulator so that the phase pattern provided by the phase modulator includes the phase component corresponding to the current scanning angle(s). The phase patterns optionally adjust the position of the scanned spot so that the scanned spot moves across powder bed 14 at a constant rate.

For example, where a galvano scanning system is used to raster scan a laser beam across powder bed 14, the phase component may provide an approximately constant spot size throughout the powder bed. The phase pattern may include the phase component, which may emulate a fixed focus lens, superposed with one or more other phase components which steer light to, for example, set a shape and/or energy distribution profile of the scanned laser beam. The phase component may be changed in synchronization with the scanning based on real-time positions of the galvano scanner. The phase component may correct for any focus distortion introduced by the galvano scanner.

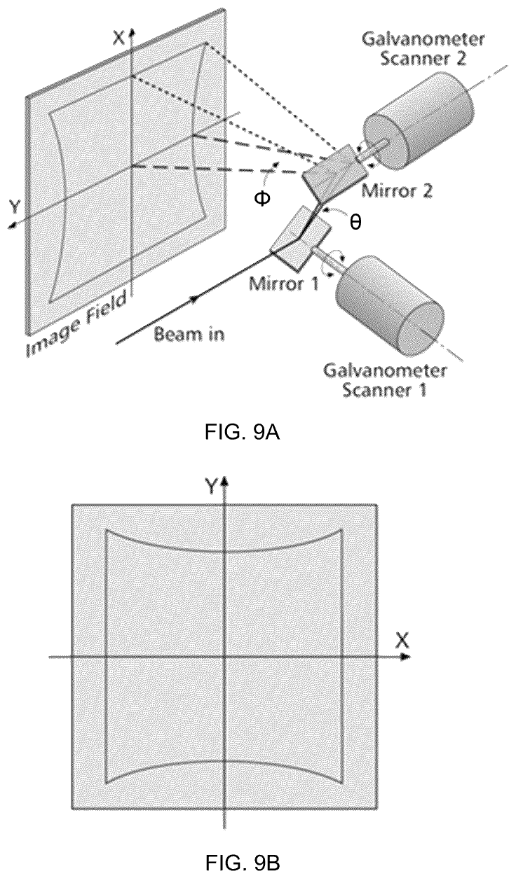

The geometry of a galvano scanner shown in FIG. 8A can also cause the points at which a scanned beam moves across powder bed 14 to follow lines that are curved. Lines at boundaries of a field that can be raster scanned for scanning angles θ and ϕ in the range of θ₁≤θ≤θ₂ and ϕ₁≤ϕ≤ϕ₂ are curved and are concave on their sides away from the field as shown in FIG. 9A. Such distortion to boundary lines is also shown in FIG. 9B. This distortion includes a position error of a laser spot.

The mirror arrangement of a galvano scanner also causes a geometric distortion of the desired beam shape that varies with scanning angles θ and ϕ of the galvano scanner.

If not compensated for, these distortions can result in geometric part inaccuracies due to the position error and/or melt-pool quality problems due to geometric beam shape distortions.

Interpolation tables and/or Nurb functions for correcting for the distortions resulting from the optical arrangement of a specific scanner may be developed in various ways. For example, a scanner may be operated to mark detectable features on a plate that is located in place of the powder bed. The features may, for example, comprise a grid of crosses (or other detectable features) marked on the plate at locations corresponding to known coordinates of the scanner axes (scanner coordinates). The actual positions of the features can then be measured. The difference between actual and desired positions of the features may be used to build the interpolation tables and/or Nurb functions.

In some embodiments a camera that images all or a portion of powder bed 14 is used to detect actual positions of the points at which a scanned point illuminates powder bed 14. These detected positions may be compared to the corresponding scanner coordinates and the difference between actual and desired positions of the illuminated points may be used to build the interpolation tables and/or Nurb functions. Such embodiments may not require a plate on which features are marked or a separate microscope for measuring positions of the features. The camera may, for example be an off-axis camera, that has a field of view that covers all or a significant portion of powder bed 14 and/or all or a significant portion of the area covered by the scanner being calibrated.

The position error distortion may be compensated by static position interpolation tables, Nurbs functions and/or a phase pattern component which may be configured to apply angle-dependent position correction.

The geometric distortion may be corrected by configuring the phase modulator to set the desired beam shape and/or energy density distribution based on the scanning angle(s) such that the desired beam shape is projected onto powder bed 14. This is illustrated in FIG. 10 for the example where the desired beam shape is circular and has a donut shape energy density distribution.

As indicated in FIG. 10 at 100-1 a beam incident on powder bed 14 is not noticeably distorted and has no noticeable position error when directed to the origin (i.e. when the beam is incident perpendicularly on powder bed 14). As indicated at 100-2 when the beam is directed off-axis there is a noticeable geometric distortion and position error in comparison to the correct beam geometry and location as indicated at 100-3. The off-axis beam may be made to be located at the correct position and to have the correct shape and power density distribution by configuring a beam as indicated at 100-4 that is pre-distorted in such a manner that the position error and geometric distortion resulting from the scanner geometry reverses the pre-distortion to achieve the correct beam 100-3. The pre-distorted beam may be generated by suitably controlling the phase modulator.

The pre-distortion may be computed in pre-processing (e.g. the geometric distortion and position shift created by the scanning system for any combination of scanning angles is known from the geometry of the scanning system and so the pre-distortion required to correct the position shift and geometric distortion can be determined in advance for each combination of scanning angles and applied to a desired beam shape and beam power density distribution). Pre-distortion may be implemented in real-time based on real-time Galvano position measurement or position estimation.

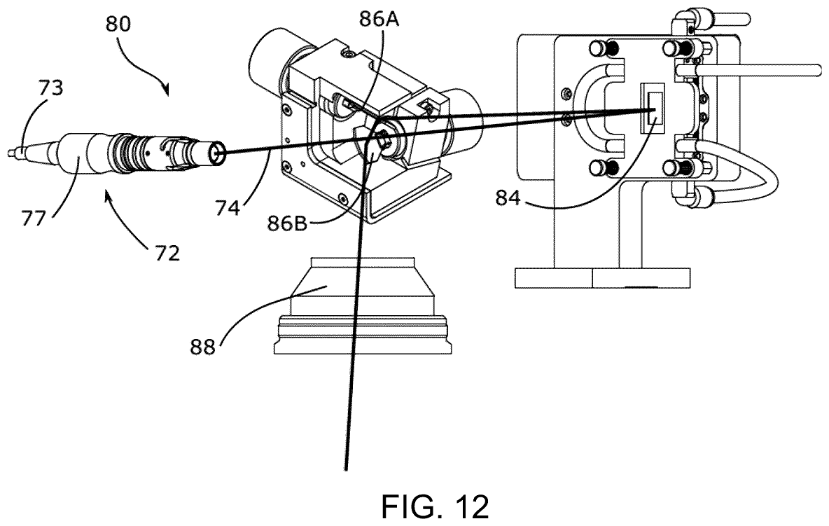

Applying a phase modulator to correct for the above distortions which result from the geometry of a scanner can advantageously improve stitching together of solidified areas of powder bed 14 created by different scanning units. The different scanning units may be arranged to scan overlapping fields. This is illustrated in FIG. 11 which shows an overlap region 151 which is within the fields of two scanner units.

Within overlap region 151 both scanners may operate to solidify powder bed 14 so as to stitch portions of the pattern specified for the different fields-of-view together with good adhesion between them. The high positional accuracy achievable through application of the present technology can help to ensure reliable stitching between fields operated on by different scanning units.

Apparatus 70 of FIG. 7 optionally includes conditioning optics 78 operative to modify properties of beam 74 upstream from beam modifier 75. Conditioning optics 78 may, for example, operate to expand beam 74, to shape the expanded beam 74 for processing by beam modifier 75 (e.g. so that beam 74 is sized and shaped to more closely match an active area of spatial light modulator 75A) and/or to collimate beam 74. In some embodiments conditioning optics 78 set a polarization of beam 74 to match a polarization for which spatial light modulator 75A is most efficient.

In some embodiments conditioning optics 78 are configured to fill an active area of a phase modulator with light having a liar/homogeneous intensity distribution. In some embodiments conditioning optics 78 are configured to fill an active area of a phase modulator with light having a Gaussian intensity distribution.

In some embodiments conditioning optics 78 shape beam 74 to better match a square or rectangular active area of a phase modulator by shaping an input beam which may be circular or nearly circular to an elliptical beam that has a size sufficient to slightly overlap edges of the active area of a downstream phase modulator. Excess light outside of the active area of the phase modulator may be blocked by an aperture.

In an example embodiment, beam 74 is circular in cross section at an entrance of conditioning optics 78, is expanded by suitable lenses of conditioning optics 78 to fill a rectangular area that matches an active area of spatial light modulator 75A, and is passed through an aperture which blocks any light that would fall outside of the active area of spatial light modulator 75A. Conditioning optics 78 may include a polarizer or set of polarizers which set a polarization of beam 74 at an entrance to beam modifier 75 to match a polarization desirable for spatial light modulator 75A. Conditioning optics 78 may increase the efficiency of dynamic beam shaping by apparatus 70.

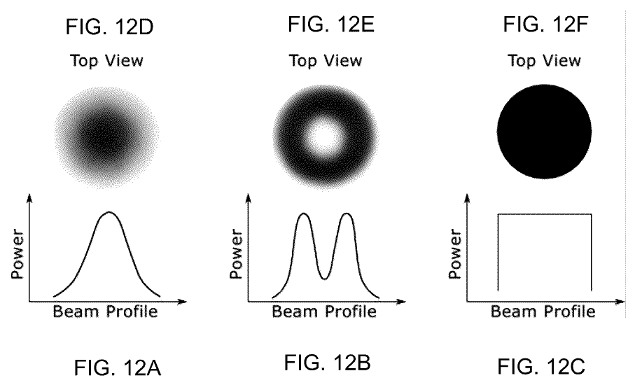

FIG. 12 shows an example additive manufacturing apparatus 80 which includes the elements of apparatus 70. Apparatus 80 includes laser source 72 which provides a laser beam 74. In this example laser beam 74 is delivered by way of an optical fiber 73 to a coupler 77. Coupler 77 may, for example, comprise a QBH fiber connector which may be water-cooled. Coupler 77 may deliver laser beam 74 into a beam conditioning unit (not shown in FIG. 12 but see e.g. beam conditioner 40 of FIGS. 4A and 4B and beam conditioning optics 78 of FIG. 7) that includes optical elements that expand and shape laser beam 74 to match the size and shape of an active area of a phase modulator 84. For example, a beam conditioning unit may shape beam 74 to have a rectangular cross-sectional shape. At the output of the beam conditioning unit, beam 74 is collimated and may have any suitable power distribution (e.g. Gaussian, uniform, etc.).

Beam 74 illuminates an active area of phase modulator 84. Pixels of phase modulator 84 are controlled to modify the shape and/or energy density profile of beam 74 by imparting selected phase shifts at different pixels of phase modulator 84. The light of beam 74 that has interacted with phase modulator 84 is steered as a result of interference to provide a modified shape and/or energy density profile.

After interacting with phase modulator 84 beam 74 is steered by scanner 76, which, in apparatus 80, comprises galvano mirrors 86A and 86B which are respectively controllable to scan beam 74 in corresponding directions across powder bed 14. Focusing optics 88 focus beam 74 onto powder bed 14.

FIGS. 12A, 12B and 12C illustrate examples of different energy distributions that may be provided by applying appropriate phase patterns to phase modulator 84. FIG. 12A shows a symmetrical Gaussian energy density profile. FIG. 12B shows an energy density profile that has a donut configuration. FIG. 12C shows an energy density profile that has a plateau configuration. FIGS. 12D, 12E and 12F are the corresponding top views of the energy distributions depicted in FIGS. 12A, 12B and 12C respectively.

Similar to the apparatus illustrated in FIG. 2, an apparatus that provides DBS is not limited to using a single phase modulator for beam shaping. For example, apparatus for dynamic beam shaping may comprise any embodiment of an exposure unit as described herein together with a scanner unit and optionally additional focusing optics. The focusing optics are optional because a phase modulator may be controlled to emulate focusing optics.

In some embodiments a beam having a controllable shape and/or a controllable energy density profile is created by combining plural beams that have been modulated by respective spatial phase modulators. The plural beams may originate from respective ones of plural laser sources or the plural beams may be obtained by splitting a beam output by one laser source. Plural spatial phase modulators may be applied to provide higher optical power levels at powder bed 14 by distributing the total laser power over a plurality of spatial phase modulators. Any of the apparatus described herein (e.g. apparatus that performs dynamic shaping and/or profiling of steered light beams (“DBS”) and/or apparatus that includes an exposure system 16 that simultaneously applies energy to a two dimensional area of powder bed 14) optionally includes a system or systems for detecting and/or correcting for unintended differences between intended and actual delivered light. Various physical effects can cause such differences. For example, changes in temperature of all or part of a spatial light modulator such as a phase modulator can change the amount of phase retardation that pixels will cause for a given control signal and/or the spatial refraction provided by the phase modulator. Such changes may, for example, result from heating of a phase modulator by a high power laser beam. As another example, physical effects such as lensing may cause changes in the intensity or energy density of a laser beam incident on a spatial light modulator. Any of these can result deviations in the pattern of steered light caused by the phase modulator from an intended pattern of steered light.

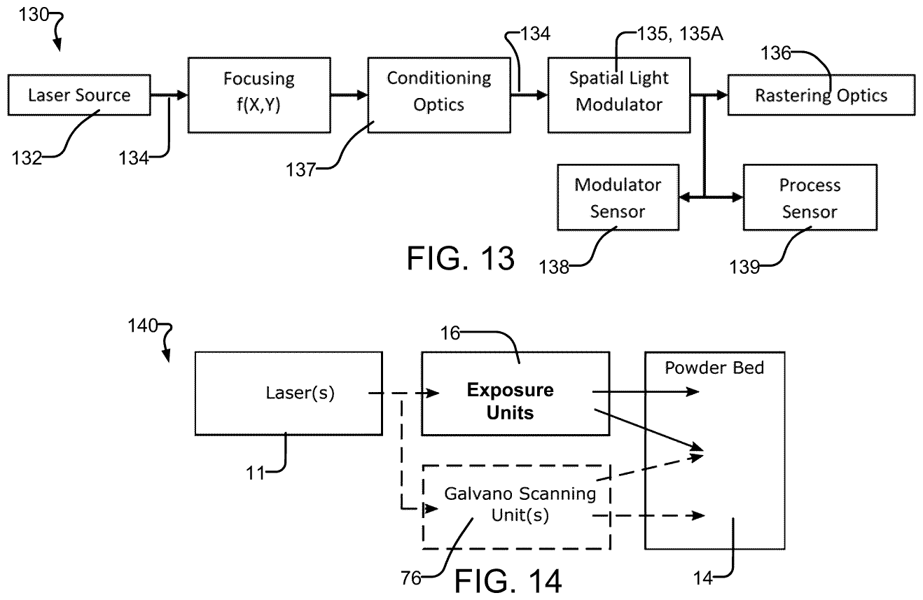

Some embodiments include sensors which monitor for such changes. FIG. 13 is a block diagram showing an example apparatus 130 with sensors that monitor light characteristics. For example, in some embodiments a system as described herein includes a modulator sensor 138 that directly or indirectly monitors a phase pattern being applied by a phase modulator 135 or other spatial light modulator 135A.

Spatial light modulator 135A can be actively controlled and adjusted based on feedback phase patterns from modulator sensor 138. In some embodiments a control system for the spatial phase modulator includes a feedback controller that adjusts control signals to the spatial light modulator 135A based on an output of modulator sensor 138 to compensate for changes in the performance of spatial light modulator 135A. For example, the image produced by the monitored phase patterns can be compared to the image produced by a desired phase pattern. If necessary, control signals for the phase modulator may be adjusted to cause the image produced by the monitored phase pattern to be closer to (preferably the same as) the image produced by the desired phase pattern. A modulator sensor 138 may, for example, comprise a 2D camera. A modulator sensor 138 may, for example, comprise an on-axis camera. In some embodiments, modulator sensor 138 comprises an off-axis camera to evaluate the light level on the phase modulator.

For example, a beam sampler in the optical illumination path may sample a fraction of the beam onto a 2D camera of sensor 138. Images captured by the 2D camera may be compared with a target energy distribution to identify errors in the energy distribution provided by spatial light modulator 135A. Such errors may be corrected by supplying the errors (which may comprise an error image) to a feedback controller operative to adjust driving signals for spatial light modulator 135A to compensate for the errors.

Some embodiments provide a sensor element (e.g. a 2D camera) arranged to monitor a beam 134 that is incident on a spatial light modulator 135A at a location upstream from spatial light modulator 135A. Such a monitor may be called a “process sensor”. A process sensor 139 may detect disturbances (e.g. thermal lensing) arising in a laser source or other upstream optical components. In some embodiments a control system for the spatial phase modulator 135A includes a feedback controller that adjusts control signals to the spatial light modulator 135A to compensate for changes in the beam 134 incident on the spatial light modulator 135A.

In some embodiments, beam 134 is split upstream of spatial light modulator 135A. For example, beam 134 may be split into a 99.5% and 0.5% divide. The 0.5% beam may be imaged at a plane that is the same path distance from the splitter as spatial light modulator 135A.

In some embodiments, outputs of a modulator sensor 138 and/or a process sensor 139 are correlated with a position of a scanned spot (e.g. with X, Y coordinates of a scanner) in apparatus as described herein which includes dynamic beam shaping functionality. The outputs of the modulator sensor 138 and/or the process sensor 139 may be used as feedback signals for helping to control the dynamic beam shaping process.

In some embodiments a scanner comprises a scanner controller operative to drive the scanner to follow a desired trajectory. For example the trajectory may be made up of a number of vectors that may be specified by a start point, an end point and a desired scan speed to be maintained between the start point and the end point. In some embodiments current coordinates of a scanner are obtained in the form of an output signal from a scanner controller. In some embodiments, a set of one or more monitored parameters (e.g. melt pool emission) is linked to the corresponding scan coordinates in a suitable data structure. In some embodiments the set of parameters in the data structure is processed to identify parameter values that correspond to possible defects. The links may be applied to determine scan coordinates which locate the possible defects on powder bed 14. The scan coordinates for the possible defects may be used to control a scanner or other mechanism to remedy the possible defects (for example, by one or more of: microscopic imaging, probing, re-melting or ablating material at the locations of the possible defects).

Another example application of DBS uses DBS to vary a width of a scanned spot based on a size of features of a part at the current location of the scanned spot. DBS may be used to make the spot small for small part features (e.g. thin walls, sharp edges). DBS may also be used to enlarge the spot size when processing larger dense features. For example, a pattern 19 for a current layer may be processed to provide a map of spot size as a function of location in the current layer. DBS may then be used to change the spot size in real time as the spot is scanned over the layer. This technique can provide increased resolution for small features while decreasing the time required to process large dense areas of the current layer.

Using DBS to provide a dynamically variable spot size can be used to pattern solid areas of a powder bed 14 but may also be applied in AM technologies which operate by initiating polymerization in light-sensitive or heat sensitive polymer precursor materials.

### 3: Combined Light Steering and Laser Scanning

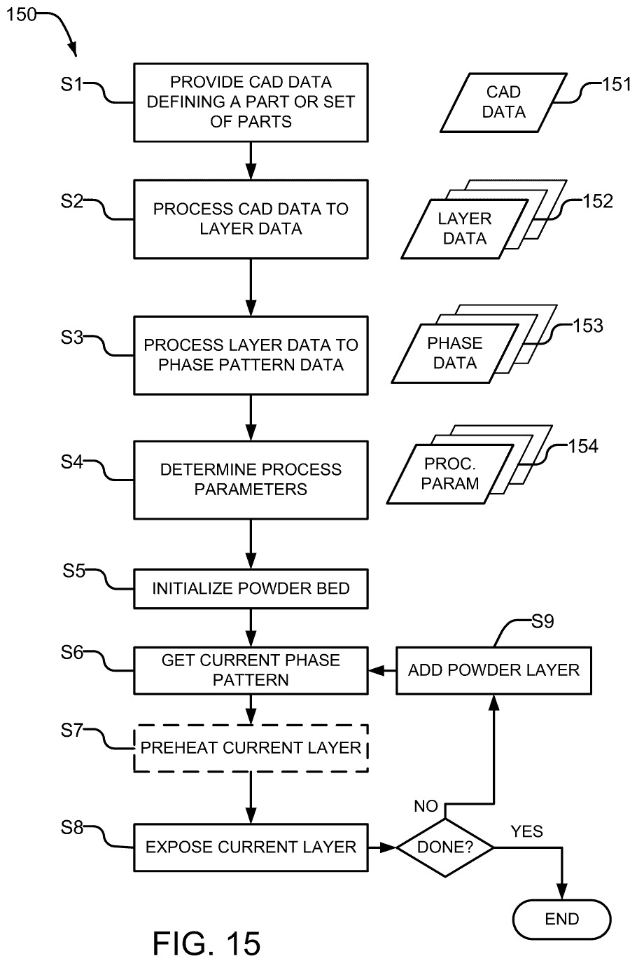

The powder bed exposure modalities described herein may be used individually or in any of a wide range of combinations. FIG. 14 is a block diagram showing an example apparatus 140 that implements combined light steering by exposure units and laser scanning. For example, apparatus for additive manufacturing 140 may comprise:
two or more exposure units 16 that each operate to expose all or a corresponding area within powder bed 14. The areas of powder bed 14 operated on by different ones of the exposure units may be the same, different or different and overlapping.
two or more scanning units 76 each capable of scanning at least one beam over a field that covers all or a selected area within powder bed 14. The areas of powder bed 14 covered by the fields of different ones of the scanning units 76 may be the same, different, or different and overlapping. Some or all of the scanning units 76 may have dynamic beam shaping capability (as described herein). Any, all or none of the scanning units 76 may comprise a gantry or other positioner operable to position a field of the scanning unit relative to powder bed 14.
one or more exposure units 16 and one or more scanning units 76.
one or more exposure units 16 that is reconfigurable as a scanning unit 76.
any combinations of the above.

Significant synergies are available in embodiments which combine at least one exposure unit 16 and at least one scanning unit 76, particularly where the at least one scanning unit 76 has DBS capabilities as described herein. Some embodiments combine an exposure unit 16 that emits light in the infrared spectrum (e.g. light having a wavelength on the order of 1000 nm and a scanning unit 76 that emits shorter wavelength light (e.g. visible light such as green light).

In some embodiments the at least one exposure unit 16 and at least one scanning unit 76 share a laser light source and possibly all optics up to and including a phase modulator 16C. In such embodiments switching between operating as an exposure unit 16 that illuminates a 2D field of view with steered light and a scanning unit 76 that has DBS capabilities may comprise switching a folding unit 16J for a scanner 76 or altering an optical path such that light that has been modulated by a phase modulator 16C is selectively passed to either a folding unit 16J operative to direct steered light to illuminate an extended 2D region of powder bed 14 or a scanner 76 operative to scan a tightly focused beam of light over powder bed 14.

Embodiments that include both an exposure unit 16 and a scanning unit 76 may be controlled to apply specified patterns of solidification to layers of powder bed 14 according to various strategies. For example, the exposure unit 16 may be applied to efficiently solidify larger contiguous areas of a current layer of powder bed 14 and the scanning unit 76 may be used to solidify areas of powder bed 14 for which the pattern for the current layer of powder bed 14 specifies fine details. The exposure unit 16 and scanning unit 76 may be applied concurrently or at separate times.

As another example, the scanning unit 76 may be controlled in response to feedback regarding defects within areas solidified by operation of an exposure unit 16 to remedy the defects, for example, by remelting and/or solidifying areas within the layer that were intended to be solidified by operation of the exposure unit 16.

For example, defects may be identified by processing images of powder bed 14. The images may correspond to one or more wavelengths. For example the images may image at wavelengths of one or more of: laser light reflected from powder bed 14, light emitted from powder bed 14 (e.g. infrared light); or other light illuminating powder bed 14 for purposes of imaging. In some embodiments a control system processes the images to identify the defects, for example using pattern recognition algorithms and/or a convolutional neural network trained to locate defects or to locate and classify defects.

Scanning unit 76 may be controlled to remedy the defects, for example by reheating locations of powder bed 14 corresponding to the defects and/or ablating the surface of powder bed 14 at locations corresponding to the defects.

As another example, while an exposure unit 16 is directing a two dimensional pattern of steered light onto powder bed 14, a scanning unit 76 may be operated to increase temperatures in areas of powder bed 14 for which monitored temperatures are undesirably low. For example, in an area of powder bed 14 for which a pattern for the current layer of powder bed 14 indicates that the layer should be solidified, a scanning unit 76 may direct additional energy to heat that area of powder bed 14 to a threshold temperature if temperature monitoring indicates that the area of powder bed 14 is below the threshold temperature. The threshold temperature may, for example be a temperature high enough to result in solidification by melting or sintering of the material of powder bed 14.

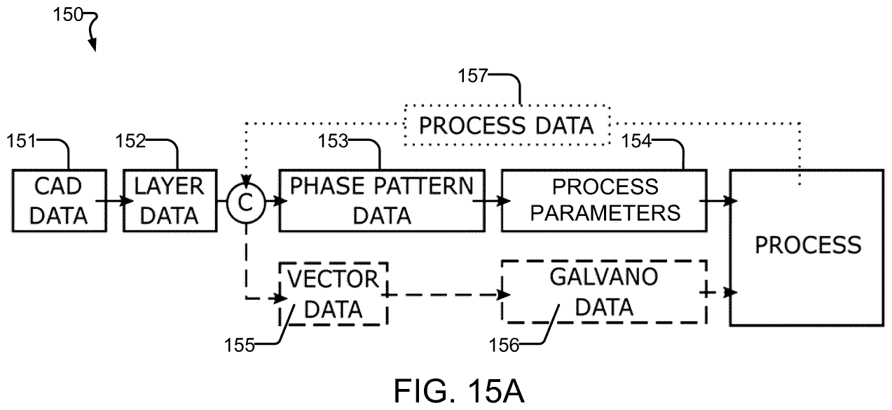

Apparatus as described herein may be used in a method for making a part. FIG. 15 is a flow chart showing a method 150 of manufacturing a part using apparatus like that shown in FIG. 13. FIG. 15A is a data flow diagram illustrating flows of data in method 150. Method 150 includes steps of:

S1. Making Computer Aided Design (CAD) data 151 for a part to be manufactured. The CAD data 151 may, for example, be made with the assistance of CAD software. Commercially available CAD software includes Solidworks™, Siemens NX™, Catia™, Solid Edge™ and others.
S2. Processing the CAD data 151 to yield layer data 152. The processing may include determining a best orientation to make the part, slicing the part into closely-spaced layers and then saving as layer data a cross-section of the part corresponding to each of the layers. Each layer represents a single slice of the part with a certain layer thickness. The layer data 152 includes a pattern which indicates areas within the corresponding layer of powder bed 14 which should be solidified.
S3. Determining phase patterns 153 for one or more phase modulators which, for each layer, will steer light to the areas of the powder bed which should be solidified. The phase patterns may be generated based on predefined process parameters.
S4. Determining process parameters 154 for creating each layer of the part. The process parameters 154 may include parameters such as one or more of: laser output power, laser duty cycle, scan speed, layer thickness, hatch spacing (distance between adjacent scan lines), preheat temperature of powder bed 14, and length of time to expose powder bed 14. Some of these parameters may be predefined. For example, some sets of parameters may be pre-set based on properties (such as sintering temperature or melting temperature) of the powder to be used in powder bed 14. Others may be based on the layer data (e.g. how fine are part features in a layer). Some of these parameters may vary between areas and/or zones within a layer. For example, hatch spacing may be varied to provide a layer that has hatch spacing that is tighter in some areas than in others.
S5. Initialize powder bed 14 with a first layer.
S6. Retrieve the phase pattern 153 for the current layer and set phase modulator of exposure unit according to the phase pattern 153.
S7. (optionally) preheat the current layer.
S8. Control the exposure unit 16 to expose the current layer sufficiently to solidify those areas of the current layer that should be solidified according to the layer data 152.
S9. If the part is not completed then make the next layer the current layer, add a new layer of powder to powder bed 14 and return to step S6.

The above example method may be modified to facilitate making parts by a combination of exposing 2D regions of powder bed 14 with exposure units 16 and scanning powder bed 14 with scanning units 76. For example, in a modified version of the above method, step S3 additionally includes processing the layer data to generate vector data 155. The vector data 155 defines areas of powder bed 14 to be scanned by one or more scanning units 76.

Vector data 155 may, for example specify a scanning pattern 156 (e.g. a raster scan and/or a scan that follows outlines of a pattern for a current layer), DBS configuration for different segments of the scanning pattern 156 and/or laser intensity for different segments of the scanning pattern 156.

The phase pattern may be applied to control an exposure unit 16 and the vector data may be applied to control a scanning unit 76 as illustrated in FIGS. 14 and 15.

In some embodiments step S3 involves updating the phase pattern and/or the vector data by real-time process feedback. For example, process data 157 (e.g. a temperature map of powder bed 14, predicted temperatures in powder bed 14, measured temperatures at one or more points around the periphery of powder bed 14 and/or an image of powder bed 14) may be acquired and fed back to step S3 which may generate an updated phase pattern 153 and/or the vector data 155 in real time.

Process feedback may be provided by way of a commercially available melt pool monitoring system, for example. Melt pool monitoring systems are described, for example, in Robert Sampson et al. An improved methodology of melt pool monitoring of direct energy deposition processes Optics & Laser Technology Vol. 127, July 2020, 106194. Melt pool monitoring systems are commercially available from companies such as SLM Solutions Group AG of Luebeck, Germany.

Some embodiments apply some of the following techniques for managing laser power output. It may be desirable to deliver little or no optical power at certain points along the trajectory of a scanned laser spot. For example, it may be desirable to deliver little or no optical power when switching between scan lines (e.g. in a raster pattern), immediately after crossing a boundary from an area of a powder bed that should be solidified to an area of the powder bed that should not be solidified, or when scanning across an area of the powder bed that should not be solidified. In such cases laser power may be reduced by one or more of:
Disabling the laser. This can be undesirable because the laser may experience some instability in operation after it is enabled again.
Turning the laser to a low power level. For some lasers the lowest operating power level may be undesirably high (e.g. 10% of maximum power). The minimum power of some fiber lasers is about 10% of the maximum power of the fiber laser.
Defocusing the spot using DBS. Increasing the spot diameter by a factor of 10 can reduce the intensity within the spot by a factor of 100.
Changing a phase pattern applied to a phase modulator to redirect the laser light to a light dump.
Adjusting a variable beam splitter (e.g. a polarizing beam splitter) to remove some light from the laser beam.
Closing a shutter in a path of the laser beam or inserting an optical attenuator in the path of the laser beam.

In some example embodiments a laser is disabled when switching from one scan vector to another scan vector to guarantee no output power. In such embodiments dynamical effects are minimized when switching (with no laser power) between two scan vectors by halting scanning for a short period (e.g. a few μs to several ms) before resuming scanning on the new scan line. This may give the laser time to come to a stable output state before scanning resumes.

Some embodiments provide feedback control systems for setting laser power output of lasers used as light sources in exposure units and/or scanners as described herein. For example, data from a modulator sensor 138 (e.g. an on-axis camera) may indicate, or may be processed to indicate, an overall level of light reflected by the phase panel. The level of reflected light is a function of the optical power output of the laser. This level may be used in an additional feedback system that controls the setpoint of the laser.

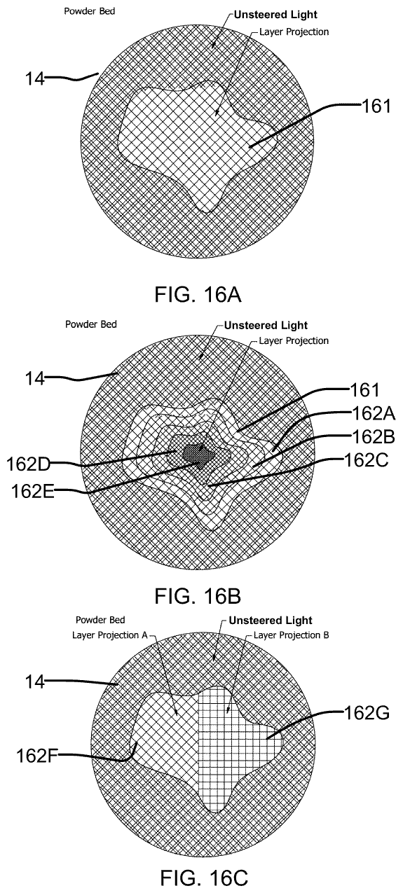

The technology described herein may be configured to apply a range of strategies for making parts. These strategies may, for example, be executed by such apparatus under control of a controller which is configured to cause the apparatus to execute such strategies to make parts. FIGS. 16A, 16B and 16C illustrate some example strategies that may be applied for patterning layers of powder bed 14 using one or more exposure units 16.

In FIG. 16A an exposure unit is operated to steer light to solidify features in an area 161 of the current layer of powder bed 14. Powder bed 14 may simultaneously be illuminated by unsteered light. The unsteered light may, for example, illuminate all of powder bed 14, a portion of powder bed 14 that includes area 161, or area 161. The unsteered light may, for example, be uniform over powder bed 14 and/or may have a fixed energy density profile designed to uniformly raise the temperature of powder bed 14. The unsteered light may originate from the same and/or different light sources from the steered light. For example:
the steered light and unsteered light may originate from separate laser sources;
at least some of the steered light may be obtained by capturing light that is reflected without phase modulation by a phase modulator of an exposure unit that supplies the steered light;
the unsteered light may be obtained by splitting light from a laser beam that supplies the steered light.

While the current layer of powder bed 14 is being patterned intensities of the steered light may be held fixed or varied (e.g. ramped up). While the current layer of powder bed 14 is being patterned intensities of the unsteered light may be held fixed or varied (e.g. ramped up).

FIG. 16B illustrates another strategy. In this example, the area 161 of the current layer of powder bed 14 that includes features to be solidified is divided into plural subsections 162. Subsections 162A to 162E are shown in FIG. 16B. Subsections 162 may overlap one another fully or partially, or may not overlap. In this example, features in different ones of subsections 162 are exposed at different times. In some embodiments, light for exposing different ones of subsections 162 is provided by different exposure units 16. The sequence of processing subsections 162 may be chosen arbitrarily. As described above, any portion or all of powder bed 14 may simultaneously be illuminated by unsteered light (advantageously area 161 receives at least some of the unsteered light). During exposure of area 161, intensities of steered and/or unsteered light may be held constant or varied.

FIG. 16C illustrates a strategy that is similar to that of FIG. 16B except that subsections 162 are shaped to facilitate exposure by different exposure units 16 either simultaneously or at different times. Subsections 162F and 162G are shown.

One problem that can be encountered when attempting to solidify an extended region of powder bed 14 by melting using light that is steered to simultaneously illuminate the extended region is that for some materials, where an extended region is melted at once, surface tension can create undesired distortions such as balling up. Various strategies may be used to alleviate or avoid this problem. Two examples of such strategies are:
use steered light to raise a temperature of powder bed 14 in the extended region to a temperature that is close to but below a solidification temperature (e.g. a melting or sintering temperature for the material of powder bed 14) and use scanned light to solidify powder bed 14 in the extended region. With this strategy the scanned light may have a lower intensity than would be necessary had the powder bed not already been heated to a temperature close to the solidification temperature and/or the scanning speed may be higher than would otherwise be possible.
control the phase modulator to dynamically vary the light steering so that the steered light within the extended region is modulated with higher and lower intensity spots that move over time. For example, the higher and lower intensity spots may form a checkerboard pattern. The higher intensity spots may deposit sufficient energy to melt the portion of powder bed that they are adjacent to at a given time and the lower intensity spots may have low enough intensity that the areas of powder bed 14 that they are adjacent to are not melted or are allowed to solidify.
after solidifying features in powder bed 14, controlling the intensity of unsteered light and/or steered light to gradually allow powder bed 14 to cool to a temperature at which a next layer of powder bed 14 may be applied.

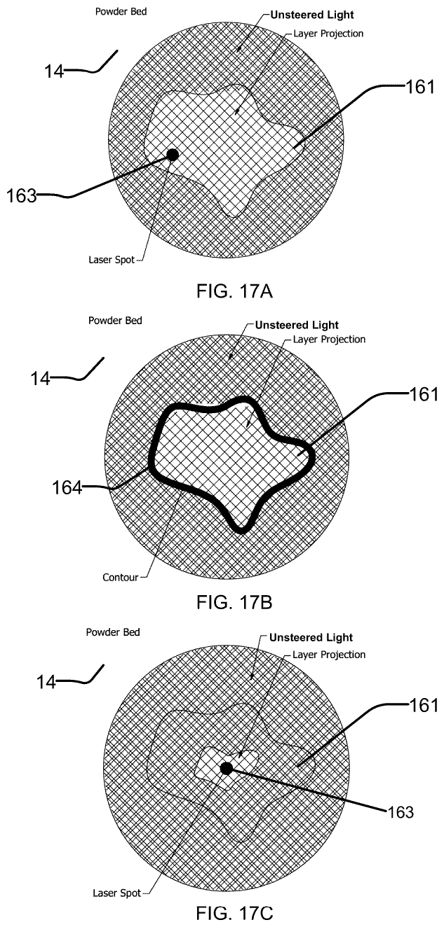

FIGS. 17A, 17B and 17C provide example strategies which combine exposure of 2D regions with steered light and exposure with scanned light. FIG. 17A illustrates strategies that are the same as those described with reference to FIG. 16A, except that, in addition a scanned light spot 163 is applied to process fine features within area 161.

FIG. 17B illustrates strategies like those of FIG. 17A except that a scanned light beam is applied to process a contour 164 extending around an area of the layer that is to be solidified.

FIG. 17C illustrates strategies that are the same as those of FIG. 16B except that in addition a scanned light spot 163 is applied to process fine features within area 161.

The methods and apparatus described herein can provide huge flexibility for making parts of different materials (even with two or more different materials in the same part), different geometries, different levels of complexity, different microstructures, and different process optimizations (e.g optimization for speed of production or optimization for high part quality).

An example of a part for which the present technology has advantages over many current AM systems is a gear. Gears have teeth which may, for example be formed on an outer periphery and/or an inner periphery (e.g. in the case of a ring gear). The teeth may have profiles (e.g. involute profiles) that should be formed to close tolerances. The teeth may be specified to have a microstructure that provides greater hardness than other parts of the gear. The body of the gear may, for example, comprise a solid mass with no small features. The present technology may be applied to quickly solidify a powder bed to create a layer of the body of the gear (e.g. using one or more exposure units as described herein alone or together with one or more scanned spots). The teeth may be precisely formed with the specified microstructure by scanning a spot shaped using DBS possibly in combination with accurate preheating and/or post-heating using the techniques described herein.

### Creating Phase Patterns

Many of the embodiments described herein include a phase modulator that is controlled to one or more of: shape a light beam, alter an energy density profile of a light beam and steer light to selectively illuminate portions of a 2D region. Phase patterns that may be applied to a phase modulator to implement such control may be determined, for example, as described in the following references:
WO 2015/184549 A1 entitled EFFICIENT, DYNAMIC, HIGH CONTRAST LENSING WITH APPLICATIONS TO IMAGING, ILLUMINATION AND PROJECTION;
WO 2016/015163 A1 entitled NUMERICAL APPROACHES FOR FREE-FORM LENSING: AREA PARAMETERIZATION FREE-FORM LENSING.

In some embodiments pixels of a phase modulator are set to display a hologram that provides a desired steering of light.

In some embodiments phase patterns to be applied to a phase modulator are optimized to deliver a desired light steering or shaping while minimizing phase changes between adjacent pixels of a phase modulator.

Various wavelengths of light may be used as described herein. The wavelength may be selected based on the material of powder bed 14. For example, many metal powders effectively absorb light at wavelengths in the infrared region (e.g. wavelengths of about 1070 nm). For copper, wavelengths in the 300 to 500 nm range (in the blue green part of the visible spectrum) may be used as these wavelengths correspond to an absorption peak.

In some embodiments, laser sources used to provide light for exposure units 16 have output power of 800 W or more. In some embodiments, laser sources used to provide light for exposure units have an output power of 50 W or less. In some embodiments plural laser beams are combined to yield a higher-power laser beam for use in a scanner (optionally a scanner configured to perform DBS) or for use in an exposure unit as described herein.

In some embodiments, light sources comprise one or more banks of diode lasers. Light from the diode lasers is combined to yield beams for use as described herein.

In some embodiments, light sources comprise plural lasers of different wavelengths. Including slightly different wavelengths in a laser beam may reduce laser speckle. The wavelengths are preferably close enough that the accuracy of light steering by phase modulators as described herein is maintained. For example, the wavelengths of light combined in a beam may differ by a few nm.

In some embodiments light sources comprise lasers that may be pulsed (pulsed lasers). The pulsed lasers may, for example, comprise high power laser diodes. In some embodiments such pulsed lasers may be controlled to ablate materials from powder bed 14, perform surface polishing or the like.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

All patents, patent applications and other publications referenced herein are incorporated herein by reference for all purposes.

Apparatus as described herein may include control devices implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for additive manufacturing apparatus as described herein may implement methods as described herein to controllably solidify layers of a powder bed by executing software instructions in a program memory accessible to the processors.

Some embodiments of the invention provide program products. The program products may comprise any non-transitory medium which carries a set of computer-readable, computer executable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

Where a component (e.g. a light source, optical element, controller, spatial light modulator, processor, assembly, device, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

For example, while processes or blocks are presented in a given order, alternative examples may perform processes or blocks in a different order. Further, some processes or blocks may be deleted, moved, added, subdivided, combined, and/or modified to provide alternative or subcombinations. Each of these processes or blocks may be implemented in a variety of different ways. Also, while processes or blocks are at times shown as being performed sequentially, they may instead be performed simultaneously or in different sequences. It is therefore intended that the following claims are interpreted to include all such variations as are within their intended scope.

Various features are described herein as being present in “some embodiments” or “in some implementations”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

### Aspects of the Invention

The invention has a number of non-limiting aspects. Non-limiting aspects of the invention include:

1. Apparatus for additive manufacturing, the apparatus comprising:
a platform configured to support a powder bed;
a light source operable to emit a beam of light into an optical path extending to a location of the powder bed, the optical path including a phase modulator having an active area comprising a two-dimensional array of pixels, the pixels individually controllable to apply phase shifts to light interacting with the pixels;
a controller connected to configure the pixels of the phase modulator to apply selected patterns of phase shifts to light incident on the active area of the phase modulator such that an energy density profile of the light incident at the location of the powder bed is determined at least in part by a current pattern of phase shifts applied by the phase modulator.
   2. The apparatus according to aspect 1 wherein the controller is configured to control the beam of light at least in part by controlling the phase modulator to selectively solidify portions of a top layer of the powder bed.
   3. The apparatus according to aspect 2 wherein the solidifying comprises sintering particles in the top layer of the powder bed.
   4. The apparatus according to aspect 2 wherein the solidifying comprises melting particles in the top layer of the powder bed.
   5. The apparatus according to any of aspects 2 to 4 wherein the controller is configured to preheat the powder bed prior to the solidifying.
   6. The apparatus according to aspect 5 wherein the controller is configured to preheat the powder bed prior to the solidifying by controlling the phase modulator to provide a preheat phase shift pattern.
   7. The apparatus according to any of aspects 2 to 6 wherein the controller is configured to post-heat the powder bed after the solidifying.
   8. The apparatus according to aspect 7 wherein the controller is configured to post-heat the powder bed after the solidifying by controlling the phase modulator to provide a post-heat phase shift pattern.
   9. The apparatus according to any of aspects 1 to 8 comprising conditioning optics between the light source and the phase modulator, the conditioning optics configured to expand a cross section of the beam and to shape the beam to fill a rectangular area that matches an active area of the phase modulator.
   10. The apparatus according to aspect 9 wherein the conditioning optics comprise an aperture located and sized to block light that would fall outside of the active area of the phase modulator.
   11. The apparatus according to aspect 9 or 10 wherein the conditioning optics comprise a polarizer oriented to set a polarization of the beam to match a polarization of the phase modulator.
   12. The apparatus according to any of the previous aspects wherein the light source is a laser.
   13. The apparatus according to aspect 12 wherein the laser is a pulsed laser.
   14. The apparatus according to aspect 12 wherein the laser is a continuous laser.
   15. The apparatus according to any of aspects 12 to 14 wherein the laser has an output power of at least 500 Watts.
   16. The apparatus according to any of aspects 12 to 14 wherein the laser has an output power of at least 1000 Watts.
   17. The apparatus according to any of aspects 12 to 14 wherein the laser has an output power of 50 Watts or less.
   18. The apparatus according to any of aspects 12 to 17 wherein the light source comprises a plurality of lasers that are combined to yield a higher-power laser beam.
   19. The apparatus according to aspect 18 wherein the light source comprises one or more banks of semiconductor lasers.
   20. The apparatus according to aspect 18 or 19 wherein the light source comprises plural lasers of different wavelengths.
   21. The apparatus according to aspect 20 wherein the wavelengths of the plural lasers differ by 20 nm or less.
   22. The apparatus according to any of aspects 12 to 21 wherein the light source emits polarized light.
   23. The apparatus according to any of the previous aspects comprising an amplitude modulator in the optical path.
   24. The apparatus according to aspect 23 wherein the amplitude modulator is operable to refine the 2D pattern of light.
   25. The apparatus according to aspect 24 wherein the controller is configured to control the amplitude modulator to straighten edges or remove high intensity artifacts from the 2D pattern.
   26. The apparatus according to any of the previous aspects wherein the phase modulator is a first phase modulator of a plurality of phase modulators that includes at least a second phase modulator, the optical path comprises a beam splitter arranged to split the beam from the light source into a first part that is directed to illuminate the active area of the first phase modulator and a second part that is directed to illuminate the active area of the second phase modulator, and the optical path comprises a beam combiner arranged to combine light that has interacted with the first and second phase modulators before the combined light is delivered to the location of the powder bed.
   27. The apparatus according to aspect 26 wherein the beam splitter is configured to make the first part of the light and the second part of the light carry substantially equal optical power.
   28. The apparatus according to aspect 26 or 27 wherein the controller is configured to apply the same pattern of phase shifts to the first phase modulator and the second phase modulator.
   29. The apparatus according to any of aspects 26 to 28 wherein the beam splitter is a polarizing beam splitter and the apparatus comprises a wave plate located in a portion of the optical path between the beam splitter and the second phase modulator.
   30. The apparatus according to aspect 29 wherein the wave plate is a half wave plate.
   31. The apparatus according to any of aspects 26 to 30 wherein the beam combiner is a polarizing beam combiner and the apparatus comprises a second wave plate located in a portion of the optical path between the first phase modulator or the second phase modulator and the beam combiner.
   32. The apparatus according to aspect 31 wherein the second wave plate is located in a portion of the optical path between the first phase modulator and the beam combiner.
   33. The apparatus according to aspect 32 wherein the second wave plate is a half wave retarder.
   34. The apparatus according to any of the previous aspects wherein the powder bed is enclosed in a controlled atmosphere enclosure.
   35. The apparatus according to aspect 34 wherein the controlled atmosphere enclosure is filled with an inert gas.
   36. The apparatus according to aspect 34 or 35 wherein the controlled atmosphere enclosure comprises a window and the optical path passes through the window.
   37. The apparatus according to any of the previous aspects comprising an elevator operable to adjust a vertical elevation of the platform.
   38. The apparatus according to aspect 37 wherein the controller is configured to operate the elevator to maintain a top surface of the powder bed at a fixed elevation.
   39. The apparatus according to any of the previous aspects comprising a source of unsteered light operable to illuminate all or part of a top surface of the powder bed.
   40. The apparatus according to aspect 39 wherein the source of unsteered light comprises optical elements arranged to collect light that is specularly reflected by the phase modulator and to deliver the light that has been specularly reflected by the phase modulator to the location of the powder bed.
   41. The apparatus according to aspect 39 or 40 wherein the source of unsteered light comprises one or more additional light sources.
   42. The apparatus according to any of aspects 40 to 41 wherein the source of unsteered light comprises a beam splitter arranged to split light from the beam emitted by the light source.
   43. The apparatus according to any of aspects 40 to 42 wherein the controller is configured to adjust relative amounts of the unsteered light and the light that has been phase shifted by the phase modulator.
   44. The apparatus according to any of the previous aspects comprising one or more heaters operable to direct heat into the powder bed.
   45. The apparatus according to aspect 44 wherein the one or more heaters comprise one of or any combination of two or more of:
one or more additional light sources configured to direct optical energy onto the location of the powder bed;
one or more resistive heater elements;
one or more sources of microwave energy;
one or more inductive heaters; and
one or more susceptors in combination with a source of radiofrequency or microwave energy.
   46. The apparatus according to any of the previous aspects wherein the beam is projected onto the location of the powder bed in a 2D pattern of optical radiation.
   47. The apparatus according to aspect 46 wherein the 2D pattern covers at least 10% of an area of the powder bed.
   48. The apparatus according to aspect 47 wherein the 2D pattern covers at least 20% of an area of the powder bed.
   49. The apparatus according to aspect 48 wherein the 2D pattern covers substantially all of an area of the powder bed.
   50. The apparatus according to any of aspects 46 to 49 wherein the 2D pattern covers an area having a size of 300 mm by 300 mm or more.
   51. The apparatus according to any of aspects 46 to 49 wherein the 2D pattern covers an area having a size of 300 mm by 300 mm or less.
   52. The apparatus according to any of aspects 46 to 51 wherein the controller is configured to control the phase modulator to present a light steering phase pattern that causes light from the beam to be steered to form the 2D pattern of light wherein the steering steers light away from certain parts of the 2D pattern and to form low intensity portions of the 2D pattern and concentrates the light at other areas of the 2D pattern to form high intensity portions of the 2D pattern.
   53. The apparatus according to aspect 52 wherein the controller is configured to control the phase modulator based on a pattern for a layer of the powder bed, the pattern comprising digital data indicating portions of a layer of the powder bed that are to be made solid and other portions of the layer of the powder bed that should not be made solid and the controller is configured to select the light steering phase pattern to steer the light in the beam so that the light is concentrated in the portions of the layer of the powder bed that are to be made solid and steered away from the portions of the layer of the powder bed that are not to be made solid.
   54. The apparatus according to aspect 52 wherein the light steering phase pattern comprises a phase pattern that concentrates light of the beam into a shape superposed with a wedge having a variable wedge angle and the controller is configured to vary the wedge angle to cause the shape to scan in a direction across the powder bed.
   55. The apparatus according to aspect 54 wherein the shape is a circle, line, square, rectangle, obround, or oval.
   56. The apparatus according to any of the preceding aspects wherein the beam emitted by the light source has a Gaussian energy distribution.
   57. The apparatus according to any of the preceding aspects wherein the controller is configured to apply feedback control by modifying the phase pattern in response to feedback from one or more sensors.
   58. The apparatus according to aspect 57 wherein the one or more sensors include a camera operative to obtain high resolution images of the location of the powder bed.
   59. The apparatus according to aspect 57 or 58 wherein the one or more sensors include a camera located to image the location of the powder bed by way of a portion of the optical path.
   60. The apparatus according to any of aspects 57 to 59 wherein the controller is configured to process the feedback from the one or more sensors to determine that an area of a current layer of the powder bed has been solidified.
   61. The apparatus according to any of aspects 57 to 60 wherein the feedback control includes controlling the temperature of areas of the powder bed that are to be solidified in the current layer and controlling the temperature of areas of the powder bed that are not to be solidified in the current layer using separate feedback loops.
   62. The apparatus according to any of the preceding aspects wherein the controller is configured to dynamically vary a phase pattern of the phase modulator by applying a first phase pattern that provides defocused or uniform illumination of an area of the powder bed followed by a second phase pattern that provides focused illumination of one or more areas of the powder bed.
   63. The apparatus according to any of the preceding aspects wherein the light source and optical path are provided by a first exposure unit and the apparatus comprises a plurality of exposure units each comprising a corresponding light source and a corresponding optical path.
   64. The apparatus according to aspect 63 wherein two or more of the plurality of exposure units illuminate the same area of the powder bed.
   65. The apparatus according to aspect 63 wherein two or more of the plurality of exposure units illuminate overlapping areas of the powder bed.
   66. The apparatus according to aspect 63 wherein each of the plurality of exposure units illuminates a distinct area of the powder bed.
   67. The apparatus according to aspect 63 wherein some of the plurality of exposure units are configured to deliver unsteered light and/or defocused steered light to the powder bed.
   68. The apparatus according to any of the preceding aspects wherein the controller is configured to adjust the energy density profile of the light incident at the location of the powder bed by one or more of:
changing a power of the light source;
changing the phase pattern to reduce the optical power directed to areas of the powder bed that should not be solidified if those areas have a temperature that exceeds a threshold; and/or
interrupting delivery of light from the beam to the location of the powder bed.
   69. The apparatus according to any of the preceding aspects comprising a beam shaping unit in the optical path between the light source and the phase modulator wherein the beam shaping unit includes optical elements that expand and shape the beam to cover the active area of the phase modulators.
   70. The apparatus according to aspect 69 wherein the beam shaping unit includes a collimator.
   71. The apparatus according to any of the preceding aspects wherein an energy distribution of the beam on the active area of the phase modulator is substantially uniform.
   72. The apparatus according to any of the preceding aspects comprising a heat sink in thermal contact with the phase modulator.
   73. The apparatus according to aspect 72 wherein the heat sink is cooled by a Peltier cooler.
   74. The apparatus according to any of the preceding aspects comprising an aperture spaced apart from the phase modulator, the aperture being sized to pass light incident on the active area of the phase modulator and to block light incident on the phase modulator and outside of the active area.
   75. The apparatus according to any of the preceding aspects wherein the optical path delivers the light to be obliquely incident at the location of the powder bed.
   76. The apparatus according to aspect 75 wherein light incident on different parts of an area illuminated by light from the optical path at the location of the powder bed is incident on the powder bed at different oblique angles.
   77. The apparatus according to aspect 75 or 76 wherein the controller is configured to include in the pattern of phase shifts a phase component that acts as a f-theta lens.
   78. The apparatus according to any of aspects 75 to 77 wherein the controller is configured to include in the pattern of phase shifts a phase component that compensates for geometric distortions resulting from the oblique angles of incidence of light on the powder bed.
   79. The apparatus according to any of the preceding aspects wherein the controller is configured to ‘auto-focus’ the light beam onto the location of the powder bed.
   80. The apparatus according to aspect 79 wherein the auto focusing comprises iteratively adjusting an autofocus component of the phase pattern applied to the phase modulator based on images of a pattern of light at the location of the powder bed.
   81. The apparatus according to aspect 80 wherein the controller is configured to monitor a size of a spot of light on the powder bed.
   82. The apparatus according to aspect 80 or 81 wherein the controller is configured to repeat the iterative process until a size of the spot of light satisfies a criterion.
   83. The apparatus according to aspect 82 wherein the criterion comprises one or more of: the spot of light has a diameter less than a threshold diameter, the size of the spot of light is minimized.
   84. The apparatus according to any of aspects 79 to 83 wherein the autofocus phase component is a parameterized lens model and the controller is configured to perform an optimization in a parameter space of the lens model.
   85. The apparatus according to any of aspects 79 to 84 wherein the controller is configured to establish corrective phase patterns to compensate for thermal lensing for different temperatures of components of the apparatus and/or different optical power levels and to apply the corrective phase patterns to a phase modulator based on one or more measured component temperatures and/or a current optical power level.
   86. The apparatus according to any of the previous aspects comprising a scanning unit in the optical path, the scanning unit operable to scan the beam of light in at least one dimension across the location of the powder bed.
   87. The apparatus according to aspect 86 wherein the scanning unit comprises a rotating polygonal mirror.
   88. The apparatus according to aspect 86 or 87 wherein the scanning unit is operable to scan the beam of light in two dimensions across the location of the powder bed.
   89. The apparatus according to aspect 88 wherein the scanning unit comprises a pair of galvano mirrors.
   90. The apparatus according to any of aspects 86 to 89 comprising a gantry operable to move the scanning unit relative to the location of the powder bed.
   91. The apparatus according to aspect 90 wherein the gantry comprises an X-Y gantry.
   92. The apparatus according to any of aspects 86 to 91 comprising an actuator connected to move the scanning unit closer to or away from the location of the powder bed.
   93. The apparatus according to any of aspects 86 to 92 wherein the controller stores scanner calibration data and applies the scanner calibration data for controlling the scanning unit to steer the beam of light to specific positions on the powder bed.
   94. The apparatus according to aspect 93 wherein the controller is configured to perform a scanner calibration operation comprising controlling the scanning unit to direct the beam of light to several reference positions on the powder bed, determining actual positions of the beam of light on the powder bed, comparing the actual positions to coordinates of the reference positions and generating the scanner calibration data based on differences between the actual positions and coordinates of the corresponding reference positions.
   95. The apparatus according to any of aspects 93 and 94 wherein the scanner calibration data comprises interpolation tables and/or Nurbs functions.
   96. The apparatus according to any of aspects 93 to 95 wherein the scanner calibration data comprises a phase pattern component configured to apply angle-dependent position correction.
   97. The apparatus according to any of aspects 86 to 96 wherein the scanned beam is focused to a scanned spot by one or more lenses in the optical path.
   98. The apparatus according to aspect 97 wherein the controller is configured to control the scanning unit to scan the scanned spot across the location of the powder bed and to change the phase pattern applied to the phase modulator in coordination with one or more of: changes in a direction in which the scanned spot is scanned, changes in a speed at which the scanned spot is being scanned, a location of the scanned spot relative to features of a part and changes in a spacing between a current scan line and an adjacent scan line.
   99. The apparatus according to aspect 98 wherein the controller is configured to set the phase pattern to provide a distribution of optical energy in the scanned spot that is not circularly symmetric and the controller is configured to alter the phase pattern to adjust an orientation of the distribution of optical energy relative to a direction of scanning the scanned spot.
   100. The apparatus according to aspect 98 or 99 wherein the controller is configured to change the phase pattern applied to the phase modulator in real time to alter one or more of the size, shape and energy distribution of the scanned beam.
   101. The apparatus according to any of aspects 98 to 100 wherein the controller is configured to adjust a size of the scanned spot based on a hatch spacing between adjacent scan lines at the location of the scanned spot.
   102. The apparatus according to any of aspects 98 to 101 wherein the controller is configured to adjust a size of the scanned spot based on an energy density required to solidify a material of the powder bed.
   103. The apparatus according to any of aspects 98 to 102 wherein the controller is configured to adjust a size of the scanned spot based on a process speed requirement.
   104. The apparatus according to any of aspects 98 to 103 wherein the scanned spot fits within a circle having a diameter of less than 150 μm or less than 80 μm or less than 60 μm or less than 40 μm.
   105. The apparatus according to any of aspects 98 to 104 wherein the controller is configured to adjust the phase pattern on the phase modulator to vary a distribution of optical energy in the scanned spot based on one or more of:
how close is the location of the scanned spot to an edge of an area of the powder bed that is to be a solid area;
how small are features of a part being made that are close to a current location of the scanned spot;
is the scanned spot approaching a boundary between an area of the powder bed that should be solidified and an area of the powder bed that should not be solidified;
how recently were other points scanned that are adjacent to the point currently illuminated by the scanned spot;
properties of the material of the powder bed; and
a radius of curvature of a path along which the scanned spot is being scanned.
   106. The apparatus according to any of aspects 98 to 105 wherein the controller is configured to adjust the phase pattern on the phase modulator to vary a distribution of optical energy in the scanned spot based on a desired profile of temperature vs. time for points in the powder bed.
   107. The apparatus according to any of aspects 98 to 106 wherein the controller is configured to selectively apply a phase pattern to the phase modulator that acts to flatten the distribution of optical energy in the scanned spot or make the distribution of optical energy more peaked.
   108. The apparatus according to any of aspects 98 to 107 wherein the controller is configured to selectively apply a phase pattern to the phase modulator that acts to make the distribution of optical energy in the scanned spot weighted more heavily to one side of a direction of scanning and weighted less heavily to another side of the direction of scanning.
   109. The apparatus according to any of aspects 98 to 108 wherein the controller is configured to selectively apply a phase pattern to the phase modulator that acts to shape the optical energy distribution to have a “donut” configuration in which a ring of higher energy density surrounds an area of lower energy density.
   110. The apparatus according to any of aspects 98 to 108 wherein the controller is configured to selectively apply a phase pattern to the phase modulator that acts to shape the optical energy distribution to have a cross (X) or plus (+) shaped configuration.
   111. The apparatus according to any of aspects 98 to 110 wherein the controller is configured to selectively apply a phase pattern to the phase modulator that acts to shape the energy distribution to have a letter V or letter H-shaped configuration.
   112. The apparatus according to any of aspects 98 to 111 wherein the controller is configured to selectively apply a phase pattern to the phase modulator that acts to shape the optical energy distribution to be elongated.
   113. The apparatus according to aspect 112 wherein the elongation is parallel to a direction of scanning of the scanned spot.
   114. The apparatus according to any of aspects 98 to 113 wherein the controller is configured to apply a phase pattern to the phase modulator that causes the scanned spot to have a letter V- or H- or I- or A-shaped energy distribution and to adjust the phase pattern so that a symmetry axis of the energy distribution is aligned with a current scanning direction of the scanned spot.
   115. The apparatus according to aspect 112 wherein the elongation is perpendicular to a direction of scanning of the scanned spot.
   116. The apparatus according to aspect 112 wherein the elongation is at an acute angle to a direction of scanning of the scanned spot.
   117. The apparatus according to any of aspects 98 to 116 wherein the controller comprises stored configuration data that associates preferred beam shapes to each of a plurality of different part features and is configured to selectively apply a phase pattern to the phase modulator that configures the phase modulator to provide an optical energy distribution for the scanned spot that has a shape corresponding to a part feature at the current location of the scanned spot.
   118. The apparatus according to aspect 117 wherein the part feature is selected from: a thin wall; a sharp corner; an interior of a solid area; a feature requiring enhanced precision; and a feature requiring particular microstructure.
   119. The apparatus according to any of aspects 98 to 118 wherein the controller comprises stored configuration data that associates preferred beam shapes to each of a plurality of different materials and is configured to selectively apply a phase pattern to the phase modulator that configures the phase modulator to provide an optical energy distribution for the scanned spot that has a shape corresponding to a material present in the powder bed at the current location of the scanned spot.
   120. The apparatus according to any of aspects 106 to 119 wherein the controller is configured to process patterns for layers of a part being made to identify features, materials and/or microstructure that lie along different scan lines and to set a sequence of beam shapes and/or other beam parameters to use for the parts of each scan line corresponding to the different features and to control the beam in real time as the scanned spot is scanned along the scan line by setting the phase modulator to provide phase patterns that shape the optical energy distribution of the scanned spot to provide the sequence of beam shapes.
   121. The apparatus according to any of aspects 98 to 120 wherein the controller is configured to vary a width of the scanned spot based on a size of features of a part at the current location of the scanned spot.
   122. The apparatus according to aspect 121 wherein the controller is configured to process a pattern for a current layer to provide a map of spot size as a function of location in the current layer and to control the phase modulator to change the size of the scanned spot in real time as the scanned spot is scanned over the powder bed to form the current layer.
   123. The apparatus according to any of aspects 86 to 122 wherein the controller is configured to process layer data that indicates which areas of a current layer of the powder bed are to be solidified and to determine from the layer data a path for scanning the scanned spot over the location of the powder bed.
   124. The apparatus according to aspect 123 wherein the controller is configured to process the layer data to determine parameters for different points along the path for scanning the beam.
   125. The apparatus according to aspect 123 wherein the parameters include one or more of: beam intensity; beam spot size; beam power density profile; beam shape; behavior of a dynamic beam component; and orientation of the beam profile relative to the scanning direction.
   126. The apparatus according to any of aspects 98 to 125 comprising a data store containing process window data that defines one or more process windows for each of one or more materials of the powder bed, the process window data specifying ranges for a plurality of process beam parameters, wherein the controller is configured to set the process beam parameters to be within one of the process windows.
   127. The apparatus according to aspect 126 wherein the process beam parameters include beam energy density, beam scanning speed, and powder bed temperature.
   128. The apparatus according to aspect 126 or 127 wherein the process window data includes plural process windows for a particular material that respectively correspond to different characteristics of the particular material, when solidified.
   129. The apparatus according to any of aspects 98 to 128 wherein the controller is configured to control the phase pattern by feedback control based on one or more feedback signals.
   130. The apparatus according to aspect 129 wherein the apparatus includes an infrared camera or a thermal imager and the feedback signals include data from the thermal imager or infrared camera.
   131. The apparatus according to aspect 129 or 130 wherein the apparatus includes a camera located to image the location of the powder bed and the feedback signals include images of the powder bed obtained by the camera.
   132. The apparatus according to any of aspects 129 to 131 comprising one or more temperature sensors located to sense temperatures around a periphery of the powder bed wherein the feedback signals include output signals from the one or more temperature sensors.
   133. The apparatus according to any of aspects 129 to 131 comprising a light detector arranged to monitor process light wherein the feedback signals include an output signal of the process light detector.
   134. The apparatus according to aspect 133 wherein the feedback signals include signals indicating one or both of intensity and wavelength spectrum of the process light.
   135. The apparatus according to any of aspects 129 to 134 comprising an acoustic or vibration sensor wherein the feedback signals include an output signal from the acoustic or vibration sensor.
   136. The apparatus according to any of aspects 129 to 135 wherein the controller is configured to generate the feedback based on properties of a previous layer of the powder bed.
   137. The apparatus according to any of aspects 86 to 136 wherein the controller is configured to operate the scanning unit to scan the scanned spot in a scan pattern that is: uni-directional; bi directional or “zig-zag”; includes island patterns; or includes exclusion patterns.
   138. The apparatus according to aspect 137 wherein the controller is configured to alter the hatch spacing of the scan patterns.
   139. The apparatus according to aspect 137 or 138 wherein the controller is configured to apply a phase pattern for the phase modulator in coordination with scanning the scanned spot according to the scan patterns.
   140. The apparatus according to aspect 139 wherein when the scanning is unidirectional scanning the controller is configured to defocus the scanned light spot to add preheat to the powder bed while the scanning unit is repositioning to the start of the next scan line.
   141. The apparatus according to aspect 140 wherein the controller is configured to shape the width of the scanned light spot based on the hatch spacing of the scan pattern.
   142. The apparatus according to aspect 139 wherein the controller is configured to adjust a length of the scanned light spot along a scanning direction in response to a scanning speed.
   143. The apparatus according to aspect 142 wherein the controller is configured to adjust the phase pattern of the phase modulator to make the scanned light spot longer when scan speed is increased and to decrease a length of the scanned light spot in the scanning direction when scan speed is decreased.
   144. The apparatus according to aspect 139 wherein the controller is configured to defocus the scanned light spot when the scanned light spot is inside an exclusion area in an exclusion pattern and/or outside an island in an island pattern.
   145. The apparatus according to any of the preceding aspects wherein the controller is configured to alter scanning patterns in a portion of the powder bed in which a layer of the powder bed has a defect.
   146. The apparatus according to any of the preceding aspects wherein the controller is configured to compensate for changes in steering efficiency of the phase modulator by measuring a distribution of optical energy in a light field steered by the phase modulator and adjusting the control signals applied to control the phase modulator to compensate for differences between the measured distribution of optical energy and a desired distribution of the optical energy.
   147. The apparatus according to aspect 146 wherein the controller is configured to compensate for the changes in steering efficiency continuously in a feedback loop.
   148. The apparatus according to aspect 146 wherein the controller is configured to compensate for the changes in steering efficiency by feed forward control.
   149. The apparatus according to any of the preceding aspects wherein the controller is configured to selectively control the phase modulator to redirect light to a beam dump.
   150. The apparatus according to any of the preceding aspects wherein the phase pattern comprises a plurality of phase pattern components and the controller is configured to combine the phase pattern components and apply the combined phase pattern components to the phase modulator.
   151. The apparatus according to aspect 150 wherein the controller is configured to combine the phase pattern components by adding pixel values of the phase pattern components modulo 2π.
   152. The apparatus according to aspect 150 wherein the phase pattern components comprise one or more of: a component that distributes light to provide a desired pattern of energy density; a component that selectively focuses or defocuses light at the location of the powder bed; a component that compensates for variations in or deviations from ideal of the light beam incident on the phase modulator; a component that compensates for variations in the performance of and/or defects in the phase modulator; and a component that compensates for a geometry of a scanner.
   153. The apparatus according to any of the preceding aspects wherein the controller is configured to control the phase modulator to provide a lens component that acts as a variable focal length lens.
   154. The apparatus according to aspect 153 wherein the controller is configured to adjust the phase pattern to selectively focus or defocus the light beam by varying the phase pattern to change the focal length of the lens component on the fly.
   155. The apparatus according to any of the preceding aspects wherein the controller is configured to control the phase modulator with a dynamically varying phase pattern component that simulates a flat field lens or an f-theta lens.
   156. The apparatus according to aspect 155 wherein the controller stores a plurality of pre-calculated phase components that each correspond to a different range of scan angles and is configured to monitor a signal that indicates the current scanning angle(s) and control the phase modulator so that the phase pattern provided by the phase modulator includes the phase component corresponding to the current scan angle.
   157. The apparatus according to any of the preceding aspects wherein the controller is configured to control the phase modulator by applying a phase pattern that compensates for geometrical distortions caused by optical components in the optical path between the phase modulator and the location of the powder bed.
   158. The apparatus according to aspect 157 wherein the controller is configured to correct for the geometric distortion by configuring the phase modulator to set a desired beam shape and/or energy density distribution based on scanning angle(s) of the scanning unit.
   159. The apparatus according to aspect 158 wherein the desired beam shape and/or energy distribution is pre-distorted to reduce position error and geometric distortion resulting from geometry of the scanning unit.
   160. The apparatus according to any of the preceding aspects comprising a beam sampler in the optical path, the beam sampler operative to sample a fraction of the beam onto a 2D camera sensor.
   161. The apparatus according to aspect 160 wherein the controller is configured to compare images captured by the 2D camera with a target energy distribution and to identify errors in the energy distribution in the beam.
   162. The apparatus according to aspect 161 wherein the controller is configured to generate an error image indicating differences between the energy distribution in the beam and the target energy distribution and to provide the error image to a feedback controller operative to adjust driving signals for the phase modulator to compensate for the errors.
   163. The apparatus according to any of the preceding aspects comprising a process sensor element arranged to monitor a portion of the beam that is incident on the phase modulator at a location upstream from the phase modulator.
   164. The apparatus according to aspect 163 wherein the controller is configured to implement a feedback controller that automatically adjusts control signals to the phase modulator to compensate for changes in the beam incident on the phase modulator.
   165. Apparatus according to any of the preceding aspects comprising a modulator sensor having an output signal indicative of a level of light reflected by the phase modulator wherein the controller is configured to control a power output of the light source based on the output signal of the modulator sensor.
   166. The apparatus according to aspect 165 wherein the modulator sensor comprises an on-axis camera.
   167. The apparatus according to aspect 165 wherein the modulator sensor comprises an off-axis camera.
   168. Apparatus for additive manufacturing comprising
a platform configured to support a powder bed;
a system for selectively solidifying the powder bed, the system comprising:
   two or more scanning units, each of the scanning units operable to scan at least one beam over a field that covers all or a selected area within the powder bed.
      169. The apparatus according to aspect 168 wherein the areas of the powder bed covered by the fields of different ones of the scanning units are the same, different, or different and overlapping.
      170. Apparatus for additive manufacturing comprising:
a platform configured to support a powder bed;
a system for selectively solidifying the powder bed, the system comprising:
   one or more exposure units and one or more scanning units each operable to direct light onto an area of the powder bed.
      171. The apparatus according to aspect 170 wherein the one or more exposure units includes an exposure unit that is reconfigurable as a scanning unit.
      172. The apparatus according to aspect 170 or 171 wherein at least one of the one or more exposure units is operable to emit light in the infrared spectrum and at least one of the one or more scanning units is operative to emit light having a wavelength shorter than a wavelength of the light in the infrared spectrum.
      173. The apparatus according to aspect 172 wherein the at least one of the exposure units is operative to emit light having a wavelength on the order of 1000 nm.
      174. The apparatus according to aspect 172 or 173 wherein the at least one of the one or more scanning units is operable to emit visible light.
      175. The apparatus according to aspect 174 wherein the visible light is green light.
      176. The apparatus according to any of aspects 170 to 175 wherein at least one of the one or more exposure units and at least one of the one or more scanning units share a laser light source.
      177. The apparatus according to aspect 176 wherein the at least one of the one or more exposure units and the at least one of the one or more scanning units share all optics up to and including a phase modulator.
      178. The apparatus according to any of aspects 170 to 177 comprising a controller configured to control the one or more exposure units and one or more scanning units.
      179. The apparatus according to aspect 178 wherein the controller is configured to control the one or more exposure units to solidify larger contiguous areas of a current layer of the powder bed to control the one or more scanning units to solidify areas of the current layer of the powder bed for which the pattern for the current layer of the powder bed specifies finer details.
      180. The apparatus according to aspect 179 wherein the controller is configured to apply the one or more exposure units and the one or more scanning units concurrently.
      181. The apparatus according to aspect 180 wherein the controller is configured to apply the one or more exposure units and the one or more scanning units at separate times.
      182. The apparatus according to any of aspects 170 to 181 wherein the controller is configured to in response to feedback regarding defects within areas solidified by operation of the one or more exposure units, remedy the defects by remelting and/or solidifying areas within the layer.
      183. The apparatus according to aspect 182 wherein the controller is configured to identify the defects by processing images of the powder bed.
      184. The apparatus according to aspect 183 wherein the images correspond to one or any combination of a wavelength of laser light reflected from the powder bed; a wavelength of light emitted from the powder bed; a wavelength of other light illuminating the powder bed.
      185. The apparatus according to aspect 183 or 184 wherein the controller comprises a convolutional neural network trained to locate defects or to locate and classify defects.
      186. The apparatus according to any of aspects 170 to 185 wherein the controller is configured to control the one or more exposure units to directing a two dimensional pattern of steered light onto the powder bed and to control the one or more scanning units to increase temperatures of the powder bed in areas of the powder bed for which monitored temperatures are undesirably low.
      187. Apparatus for additive manufacturing comprising:
a platform configured to support a powder bed;
a system for selectively solidifying the powder bed, the system comprising:
   two or more exposure units each operable to expose all or a corresponding area within the powder bed.
      188. The apparatus according to aspect 187 wherein the areas of the powder bed illuminated by different ones of the exposure units are the same, different or different and overlapping.
      189. Apparatus according to any of aspects 165 to 188 comprising one or more laser light sources and a controller wherein the controller is configured to manage optical power delivered by the one or more lasers to the powder bed by one or more of:
Defocusing the light;
Changing a phase pattern applied to a phase modulator to redirect the laser light to a light dump;
Adjusting a variable beam splitter (e.g. a polarizing beam splitter) to remove some of the light;
Closing a shutter in a path of a beam from the laser; and
Inserting an optical attenuator in a path of a beam from the laser.
   190. The apparatus according to aspect 189 wherein the controller is configured to reduce the optical power delivered to the powder bed from the at least one laser by way of a scanning unit when switching between scan lines, after crossing a boundary from an area of the powder bed that should be solidified to an area of the powder bed that should not be solidified, or when scanning across an area of the powder bed that should not be solidified.
   191. A computer program product comprising a computer readable medium carrying computer executable instructions that when executed by a data processor of a controller of apparatus of any of the preceding aspects cause the data processor to control the apparatus as described herein.
   192. Apparatus having any new and inventive feature, combination of features, or sub-combination of features as described herein.
   193. A method of additive manufacturing, the method comprising:
guiding light from a light source to the location of a powder bed on an optical path that includes a phase modulator;
controlling the phase modulator to apply a 2D pattern of phase shifts to the light, the phase shifts steering the light onto the powder bed to yield a desired optical power distribution on the powder bed; and
the optical power distribution selectively solidifying areas in a top layer of the powder bed.
   194. The method according to aspect 193 wherein the optical power distribution covers an area of at least 90 cm 2.
   195. The method according to aspect 193 wherein the optical power distribution covers at least 10% of an area of the powder bed.
   196. The method according to aspect 193 wherein the optical power distribution covers at least 20% of an area of the powder bed.
   197. The method according to aspect 193 wherein the optical power distribution covers a top surface of the powder bed.
   198. The method of any of the preceding aspects comprising sequentially adding layers to the powder bed and selectively solidifying parts of each of the layer to form a part.
   199. The method according to aspect 198 comprising providing a pattern for each of the layers and determining the phase pattern for the phase modulator based at least in part on the phase pattern.
   200. The method according to any of the preceding aspects wherein the optical path includes an amplitude modulator between the phase modulator and the location of the powder bed and the method comprises controlling the amplitude modulator to refine the optical power distribution.
   201. The method according to aspect 200 wherein refining the optical power distribution comprises one or more of:
straightening edges; and
removing high intensity artifacts.
   202. The method according to any of the preceding aspects comprising heating the powder bed.
   203. The method according to aspect 202 wherein heating the powder bed comprises directing unsteered light onto the powder bed.
   204. The method according to aspect 203 comprising collecting the unsteered light from the phase modulator.
   205. The method according to any of aspects 202 to 204 comprising operating additional light sources to provide the unsteered light.
   206. The method according to any of aspects 202 to 205 comprising diverting light from the optical path to provide the unsteered light.
   207. The method according to any of aspects 202 to 206 wherein heating the powder bed comprises applying a pattern of phase shifts to the phase modulator that defocuses the optical power density.
   208. The method according to any of aspects 202 to 207 comprising applying the heating before the material of the powder bed is solidified.
   209. The method according to any of aspects 202 to 208 comprising applying the heating after the material of the powder bed is solidified.
   210. The method according to any of the preceding aspects comprising cooling the powder bed after solidifying the areas of the top layer of the powder bed.
   211. The method according to aspect 210 wherein cooling the powder bed comprises applying a cooled gas to one or more areas, or the whole, of the surface of the powder bed.
   212. The method according to any of the preceding aspects comprising shaping the light incident on the phase modulator to match or nearly match a size and shape of an active area of the phase modulator.
   213. The method according to any of the preceding aspects comprising applying the optical power distribution to selectively melt material in areas of the powder bed.
   214. The method according to any of the preceding aspects comprising applying the optical power distribution to selectively sinter material in areas of the powder bed.
   215. The method according to any of the preceding aspects wherein the optical path includes a light scanner and the method comprises operating the light scanner to move the optical power distribution over the location of the powder bed.
   216. The method according to aspect 215 comprising changing the pattern of phase shifts applied by the phase modulator as the optical energy distribution is being moved.
   217. The method according to aspect 216 comprising changing the phase pattern in response to change of a direction of the scanning of the optical power distribution.
   218. The method according to any of aspects 215 to 217 comprising scanning the optical power density across the location of the powder bed and altering the pattern of phase shifts applied to the phase modulator in coordination with one or more of: changes in a direction in which the scanned spot is scanned, changes in a speed at which the scanned spot is being scanned, a location of the scanned spot relative to features of a part and changes in a spacing between a current scan line and an adjacent scan line.
   219. The method according to any of aspects 215 to 218 comprising changing the pattern of phase shifts applied to the phase modulator in real time to alter one or more of the size, shape and energy distribution of the optical power density.
   220. The method according to any of aspects 215 to 219 comprising applying stored scanner calibration data for controlling the scanning unit to steer the light to specific positions on the powder bed.
   221. The method according to aspect 220 comprising performing a scanner calibration operation comprising controlling the scanning unit to direct light to several reference positions on the powder bed, determining actual positions of the light on the powder bed, comparing the actual positions to coordinates of the reference positions and generating the scanner calibration data based on differences between the actual positions and coordinates of the corresponding reference positions.
   222. The method according to any of aspects 220 to 221 wherein the scanner calibration data comprises interpolation tables and/or Nurbs functions.
   223. The method according to any of aspects 220 to 222 wherein the scanner calibration data comprises a phase pattern component configured to apply angle-dependent position correction.
   224. The method according to any of aspects 215 to 219 wherein the optical path includes one or more focusing elements and the method comprises focusing the optical power distribution to provide a scanned spot on the powder bed.
   225. The method according to aspect 224 wherein the scanned spot fits within a circle having a diameter of less than 150 μm or less than 80 μm or less than 60 μm or less than 40 μm.
   226. The method according to any of aspects 224 to 225 comprising setting the pattern of phase shifts applied to the phase modulator to provide a distribution of optical energy in the scanned spot that is not circularly symmetric and altering the pattern of phase shifts applied to the phase modulator to adjust an orientation of the optical power distribution relative to a direction of scanning the scanned spot.
   227. The method according to any of aspects 224 to 226 comprising adjusting a size of the scanned spot based on a hatch spacing between adjacent scan lines at the location of the scanned spot.
   228. The method according to any of aspects 224 to 227 comprising adjusting a size of the scanned spot based on an energy density required to solidify a material of the powder bed.
   229. The method according to any of aspects 224 to 227 comprising adjusting a size of the scanned spot based on a process speed requirement.
   230. The method according to any of aspects 224 to 229 comprising processing layer data that indicates which areas of a current layer of the powder bed to solidify to determine a path for scanning the scanned spot.
   231. The method according to any of aspects 224 to 230 comprising controlling one or more of:
intensity of the optical power distribution;
size of the scanned spot;
profile of the optical power distribution; and
shape of the optical power distribution;
   by adjusting the pattern of phase shifts applied to the phase modulator.
   232. The method according to any of aspects 224 to 231 wherein focusing the optical power distribution to provide the scanned spot comprises applying a focusing phase component to the phase modulator.
   233. The method according to any of aspects 224 to 232 comprising setting the pattern of phase shifts so that the optical power distribution in the scanned spot has a cross (X) or a plus (+) shaped configuration.
   234. The method according to any of aspects 224 to 232 comprising setting the pattern of phase shifts so that the optical power distribution in the scanned spot has a letter V or H-shaped configuration.
   235. The method according to any of aspects 224 to 232 comprising setting the pattern of phase shifts so that the optical power distribution in the scanned spot has a donut configuration.
   236. The method according to any of aspects 224 to 232 comprising setting the pattern of phase shifts to cause the scanned spot to be elongated in a selected direction.
   237. The method according to any of aspects 224 to 232 comprising setting the pattern of phase shifts to adjust an orientation of the optical power density to be a desired orientation relative to a direction of scanning the scanned spot.
   238. The method according to any of aspects 224 to 237 comprising selectively setting the pattern of phase shifts to focus and defocus the scanned spot as a function of position of the scanned spot on the powder bed.
   239. The method according to any of aspects 224 to 237 comprising setting the pattern of phase shifts to concentrate the optical power density on one side of a scan line along which the scanned spot is being scanned.
   240. The method according to any of aspects 224 to 239 comprising setting the pattern of phase shifts so that the optical power distribution is not circularly symmetric and has a symmetry axis and the method comprises orienting the symmetry axis to align with a direction of scanning of the scanned spot.
   241. The method according to any of aspects 224 to 240 comprising dynamically adjusting the pattern of phase shifts to cause the optical power density to be more uniform or more peaked as the scanned spot is scanned across the powder bed.
   242. The method according to any of aspects 224 to 240 comprising solidifying interior portions of an area in the powder bed by defocusing the scanned spot and scanning the defocused spot over the interior portions of the area of the powder bed.
   243. The method according to aspect 224 comprising increasing an output optical power of the light source while scanning the defocused spot over the interior portions of the area of the powder bed.
   244. The method according to any of aspects 215 to 243 comprising including in the pattern of phase shifts a phase component that compensates for geometrical distortions resulting from changes in an angle with which the light is incident on the location of the powder bed.
   245. The method according to any of aspects 224 to 244 comprising:
processing a computer model of a part to be made to provide a plurality of patterns, each of the patterns corresponding to a layer of the powder bed and indicating areas in which the layer of the powder bed is to be solidified;
processing each of the patterns to identify features of the areas, generate a scanning pattern for the layer, the scanning pattern comprising a plurality of scan lines and to determine locations of the identified features along the scan lines;
determining patterns of phase shifts corresponding to each of the features; and
scanning the scanned spot along the scan lines for a current layer of the powder bed while dynamically configuring the phase modulator to provide the patterns of phase shift corresponding to the features along the scan lines.
   246. The method according to aspect 245 wherein the part features comprise features selected from: a thin wall; a sharp corner; an interior of a solid area; a feature requiring enhanced precision, and a feature requiring a particular microstructure.
   247. The method according to any of aspects 245 to 246 comprising processing the patterns for the layers to identify features materials and/or microstructures that lie along different scan lines, setting a sequence of beam shapes and/or other beam parameters to use for the parts of each scan line corresponding to the different features and controlling the phase modulator in real time as the scanned spot is scanned along the scan line to provide phase patterns that shape the optical energy distribution of the scanned spot to provide the sequence of beam shapes.
   248. The method according to any of aspects 224 to 247 comprising varying a width of the scanned spot based on a size of features of a part at the current location of the scanned spot.
   249. The method according to aspect 248 comprising processing a pattern for a current layer to provide a map of spot size as a function of location in the current layer and controlling the phase modulator to change the size of the scanned spot in real time as the scanned spot is scanned over the powder bed to form the current layer.
   250. The method according to any of aspects 224 to 249 comprising scanning the scanned spot across the location of the powder bed and changing the pattern of phase shifts applied by the phase modulator in coordination with one or more of: changes in a direction in which the scanned spot is scanned, changes in a speed at which the scanned spot is being scanned, a location of the scanned spot relative to features of a part and changes in a spacing between a current scan line and an adjacent scan line.
   251. The method according to any of aspects 224 to 250 comprising adjusting the pattern of phase shifts on the phase modulator to vary a distribution of optical energy in the scanned spot based on one or more of:
how close is the location of the scanned spot to an edge of an area of the powder bed that is to be a solid area;
how small are features of a part being made that are close to a current location of the scanned spot;
is the scanned spot approaching a boundary between an area of the powder bed that should be solidified and an area of the powder bed that should not be solidified;
how recently were other points scanned that are adjacent to the point currently illuminated by the scanned spot;
properties of the material of the powder bed; and
a radius of curvature of a path along which the scanned spot is being scanned.
   252. The method according to any of aspects 224 to 251 comprising adjusting the phase pattern on the phase modulator to vary a distribution of optical energy in the scanned spot based on a desired profile of temperature vs. time for points in the powder bed.
   253. The method according to any of aspects 224 to 252 comprising determining preferred beam shapes for each of a plurality of different part features and selectively applying a phase pattern to the phase modulator that configures the phase modulator to provide an optical energy distribution for the scanned spot that has a shape corresponding to a part feature at the current location of the scanned spot.
   254. The method according to any of aspects 224 to 253 comprising selectively applying a phase pattern to the phase modulator that configures the phase modulator to provide an optical energy distribution for the scanned spot that has a shape corresponding to a material present in the powder bed at the current location of the scanned spot.
   255. The method according to any of aspects 224 to 254 comprising operating the scanner to scan the scanned spot in a scan pattern that is: uni-directional; bi directional or “zig-zag”; includes island patterns; or includes exclusion patterns.
   256. The method according to aspect 255 comprising altering hatch spacing of the scan patterns.
   257. The method according to any of aspects 255 to 256 comprising, wherein, when the scanning is unidirectional scanning, defocusing the scanned light spot to add preheat to the powder bed while the scanning unit is repositioning to the start of the next scan line.
   258. The method according to any of aspects 224 to 257 comprising setting a width of the scanned light spot based on a hatch spacing of a scan pattern.
   259. The method according to any of aspects 224 to 258 comprising adjusting a length of the scanned spot along a scanning direction based at least in part on a scanning speed.
   260. The method according to any of aspects 224 to 259 comprising adjusting the pattern of phase shifts of the phase modulator to make the scanned light spot longer when scan speed is increased and decreasing a length of the scanned light spot in the scanning direction when scan speed is decreased.
   261. The method according to any of aspects 224 to 260 comprising defocusing the scanned light spot when the scanned light spot is inside an exclusion area in an exclusion pattern and/or outside an island in an island pattern.
   262. The method according to any of the preceding aspects comprising monitoring applied phase shifts being applied by the phase modulator and adjusting control inputs to the phase modulator to cause the applied phase shifts to match desired phase shifts.
   263. The method according to any of the preceding aspects comprising monitoring a distribution of light incident on the phase modulator and applying a phase component to the phase modulator to compensate for changes in the distribution of light incident on the phase modulator.
   264 The method according to any of the preceding aspects comprising selectively reducing a power of the optical power density by controlling the phase modulator to redirect some light incident on the phase modulator to a beam dump.
   265. The method according to aspect 264 comprising redirecting some light incident on the phase modulator to the beam dump while reversing a scanning direction.
   266. The method according to aspect 264 comprising redirecting some light incident on the phase modulator to the beam dump in coordination with scanning the scanned spot from an area of the powder bed that is to be solidified to an area of the powder bed that is not to be solidified.
   267. The method according to any of the preceding aspects comprising dynamically varying a phase component of the pattern of phase shifts to compensate for geometrical distortions caused by scanning components in the optical path.
   268. The method according to any of aspects 193 to 267 wherein the pattern of phase shift comprises one or more parameterized phase shift components and the method comprises adjusting one or more parameters of the parameterized phase shift components to alter the optical power distribution.
   269. The method according to aspect 268 wherein the parameterized phase shift components comprise a parameterized lens.
   270. The method according to aspect 269 wherein the parameterized lens comprises a f-theta lens.
   271. The method according to aspect 269 or 270 wherein the parameters include a focal length parameter and the method comprises dynamically varying the focal length parameter as the scanned spot is moved over the powder bed.
   272. The method according to any of the preceding aspects comprising auto focusing the optical power density on the powder bed wherein auto focusing comprises iteratively adjusting an autofocus component of the phase pattern applied to the phase modulator based on images of a pattern of light at the location of the powder bed.
   273. The method according to aspect 272 comprising monitoring a size of a spot of light on the powder bed.
   274. The method according to aspect 272 or 273 comprising repeating the iterative process until a size of the spot of light satisfies a criterion.
   275. The method according to aspect 274 wherein the criterion comprises one or more of: the spot of light has a diameter less than a threshold diameter, the size of the spot of light is minimized.
   276. The method according to any of aspects 272 to 275 wherein the autofocus component of the phase pattern is a parameterized lens model and the method comprises performing an optimization in a parameter space of the lens model.
   277. The method according to any of aspects 272 to 278 comprising establishing corrective phase patterns to compensate for thermal lensing for different temperatures of components of an apparatus and/or different optical power levels and applying the corrective phase patterns to the phase modulator based on one or more measured component temperatures and/or a current optical power level.
   278. The method according to any of the preceding aspects comprising controlling the phase modulator to present a light steering pattern of phase shifts that causes light incident on the phase modulator to be steered to form a 2D pattern of light on the powder bed wherein the steering steers light away from certain parts of the 2D pattern to form low intensity portions of the 2D pattern and concentrates the light at other areas of the 2D pattern to form high intensity portions of the 2D pattern.
   279. The method according to aspect 278 comprising controlling the phase modulator based on a pattern for a layer of the powder bed, the pattern comprising digital data indicating portions of a layer of the powder bed that are to be made solid and other portions of the layer of the powder bed that should not be made solid and controlling the phase modulator comprises setting the phase modulator so that the light steering pattern of phase shifts steers the light incident on the phase modulator so that the light is concentrated in the portions of the layer of the powder bed that are to be made solid and steered away from the portions of the layer of the powder bed that are not to be made solid.
   280. The method according to aspect 278 or 279 wherein the light steering pattern of phase shifts comprises a phase pattern that concentrates light incident on the phase modulator into a shape superposed with a wedge having a variable wedge angle and the method comprises varying the wedge angle to cause the shape to scan in a direction across the powder bed.
   281. The method according to aspect 280 wherein the shape is a circle, line, square, rectangle, obround, or oval.
   282. The method according to any of aspects 278 to 281 comprising dynamically varying the pattern of phase shift of the phase modulator by applying a first phase pattern that provides defocused or uniform illumination of an area of the powder bed followed by a second phase pattern that provides focused illumination of one or more areas of the powder bed.
   283. The method according to any of the preceding aspects comprising controlling the pattern of phase shifts by feedback control based on feedback from one or more sensors.
   284. The method according to aspect 283 wherein the one or more sensors include a camera operative to obtain high resolution images of the location of the powder bed.
   285. The method according to aspect 283 or 284 wherein the one or more sensors include a camera located to image the location of the powder bed by way of a portion of the optical path.
   286. The method according to any of aspects 283 to 285 comprising processing the feedback signal from the one or more sensors to determine that an area of a current layer of the powder bed has been solidified.
   287. The method according to any of aspects 283 to 286 wherein the feedback control includes controlling the temperature of areas of the powder bed that are to be solidified in the current layer and controlling the temperature of areas of the powder bed that are not to be solidified in the current layer using separate feedback loops.
   288. The method according to any of aspects 283 to 287 wherein the sensors include one or more of an infrared camera or a thermal imager and the feedback signals include data from the thermal imager or infrared camera.
   289. The method according to any of aspects 283 to 288 wherein the sensors include a camera located to image the location of the powder bed and the feedback signals include images of the powder bed obtained by the camera.
   290. The method according to any of aspects 284 to 289 wherein the sensors comprise one or more temperature sensors located to sense temperatures around a periphery of the powder bed and the feedback signals include output signals from the one or more temperature sensors.
   291. The method according to any of aspects 283 to 290 comprising a light detector arranged to monitor process light wherein the feedback signals include an output signal of the process light detector.
   292. The method according to aspect 291 wherein the feedback signals include signals indicating one or both of intensity and wavelength spectrum of the process light.
   293. The method according to any of aspects 283 to 292 wherein the sensors comprise an acoustic or vibration sensor and the feedback signals include an output signal from the acoustic or vibration sensor.
   294. The method according to any of aspects 283 to 293 comprising generating the feedback based on properties of a previous layer of the powder bed.
   295. The method according to any of the preceding aspects comprising compensating for changes in steering efficiency of the phase modulator by measuring the distribution of optical energy in a light field steered by the phase modulator and adjusting control signals applied to control the phase modulator to compensate for differences between the measured distribution of optical energy and a desired distribution of the optical energy.
   296. The method according to aspect 295 comprising compensating for the changes in steering efficiency continuously in a feedback loop.
   297. The method according to aspect 295 comprising compensating for the changes in steering efficiency by feed forward control.
   298. The method according to any of the preceding aspects wherein the phase modulator is a first phase modulator and the method comprises combining light that has been phase shifted by the first modulator with light that has been phase shifted by a second phase modulator and directing the combined light onto the powder bed to yield the optical power distribution.
   299. The method according to aspect 298 comprising controlling the first and second phase modulators to apply the same pattern of phase shifts.
   300. The method according to any of aspects 298 to 299 comprising splitting the light from the light source into first and second beams, delivering the first beam to illuminate the first phase modulator and delivering the second beam to illuminate the second phase modulator.
   301. The method according to any of the preceding aspects comprising imaging the powder bed.
   302. The method according to aspect 301 comprising processing images of the powder bed to identify defects.
   303. The method according to aspect 301 or 302 comprising, in response to identifying a defect in a previous layer of the powder bed, altering a scanning pattern for a current layer of the powder bed.
   304. The method according to any of aspects 301 to 303 comprising ablating material at a location of the defect.
   305. The method according to aspect 304 wherein ablating the material comprises increasing a maximum intensity of the optical power density and positioning the optical power density over the location of the defect.
   306. The method according to any of aspects 301 to 305 comprising processing images of the powder bed to provide feedback signals and adjusting the phase shift pattern in response to the feedback signals.
   307. The method according to any of the preceding aspects wherein the light source comprises a laser.
   308. The method according to aspect 306 wherein the laser is a pulsed laser.
   309. The method according to aspect 307 wherein the laser is a continuous laser.
   310. The method according to any of aspects 307 to 309 wherein the laser has an output power of at least 500 Watts or at least 1000 Watts.
   311. The method according to any of aspects 306 to 308 wherein the laser has an output power of 50 Watts or less.
   312. The method according to any of aspects 306 to 311 wherein the light source comprises a plurality of lasers and the method comprises combining light output by the lasers.
   313. The method according to any of aspects 306 to 312 wherein the light source comprises one or more banks of semiconductor lasers.
   314. The method according to any of aspects 306 to 313 wherein the light from the light source comprises plural different wavelengths.
   315. The method according to aspect 314 wherein the wavelengths of the plural different wavelengths differ by 20 nm or less.
   316. The method according to any of the preceding aspects wherein the light from the light source is polarized light.
   317. The method according to any of the preceding aspects comprising looking up process window data that defines one or more process windows for each of one or more materials of the powder bed, the process window data specifying ranges for a plurality of process beam parameters, and setting the process beam parameters to be within one of the process windows.
   318. The method according to aspect 317 wherein the process beam parameters include one or more of beam energy density, beam scanning speed, and powder bed temperature.
   319. The method according to aspect 317 or 318 wherein the process window data includes plural process windows for a particular material that respectively correspond to different characteristics of the particular material, when solidified.
   320. The method according to any of the preceding aspects comprising positioning the optical power density on the powder bed by moving one or more optical components by operating a gantry.
   321. The method according to aspect 320 wherein the gantry is an X-Y gantry.
   322. The method according to any of the preceding aspects wherein the pattern of phase shifts comprises a plurality of phase pattern components and the method comprises combining the phase pattern components and applying the combined phase pattern components to the phase modulator.
   323. The method according to aspect 322 comprising combining the phase pattern components by adding pixel values of the phase pattern components modulo 2π.
   324. The method according to aspect 322 wherein the phase pattern components comprise one of more of: a component that distributes light to provide a desired pattern of optical power density; a component that selectively focuses or defocuses light at the location of the powder bed; a component that compensates for variations in or deviations from ideal of the light beam incident on the phase modulator; a component that compensates for variations in the performance of and/or defects in the phase modulator; and a component that compensates for a geometry of a scanner.
   325. The method according to any of the preceding aspects comprising controlling the phase modulator to provide a lens component that acts as a variable focal length lens.
   326. The method according to aspect 325 comprising adjusting the pattern of phase shifts to selectively focus of defocus the light beam by varying the lens component to change the focal length of the lens component on the fly.
   327. The method according to any of the preceding aspects comprising performing feedback control to automatically adjust control signals to the phase modulator to compensate for changes in the beam incident on the phase modulator based on feedback from a process sensor element arranged to monitor a portion of a light beam incident on the phase modulator at a location upstream from the phase modulator.
   328. The method according to any of the preceding aspects comprising controlling a light output of a light source based on an output signal from a modulator sensor operable to detect a level of light reflected by the phase modulator.
   329. The method according to aspect 328 wherein the modulator sensor comprises an on-axis camera.
   330. A method for the additive manufacturing of a part, the method comprising:
making a Computer Aided Design (CAD) data defining the part;
processing the CAD data to yield layer data, wherein a layer represents a single slice of the part with a certain layer thickness and the layer data includes a pattern which indicates areas within the corresponding layer of the powder bed which should be solidified;
determining phase patterns for one or more phase modulators, which for each layer will steer light to the areas of the powder bed which should be solidified;
determining process parameters for creating each layer of the part;
initializing the powder bed with a first layer; and until the part is complete repeating the steps of:
   retrieving the phase pattern for the current layer and setting a phase modulator of an exposure unit according to the phase pattern;
   controlling the exposure unit to expose the current layer sufficiently to solidify those areas of the current layer that should be solidified according to the layer data for the current layer; and
   adding a new layer of powder to the powder bed.
      331. A method comprising any new and inventive step, act, combination of steps and/or acts or subcombination of steps and/or acts as described herein.
      332. A computer program product comprising a data storage medium carrying machine readable executable instructions that when executed by a data processor cause the data processor to execute a method according to any of the preceding aspects.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-20. (canceled)

21. Apparatus for additive manufacturing, the apparatus comprising:
a platform configured to support a powder bed;
a light source operable to emit a beam of light into an optical path extending to a location of the powder bed, the optical path including a phase modulator having an active area comprising a two-dimensional array of pixels, the pixels individually controllable to apply phase shifts to light interacting with the pixels;
a controller connected to configure the pixels of the phase modulator to apply selected patterns of phase shifts to light incident on the active area of the phase modulator such that an energy density profile of the light incident at the location of the powder bed is determined at least in part by a current pattern of phase shifts applied by the phase modulator.

22. The apparatus according to claim 21 wherein the controller is configured to control the beam of light at least in part by controlling the phase modulator to selectively solidify portions of a top layer of the powder bed.

23. The apparatus according to claim 21 comprising conditioning optics between the light source and the phase modulator, the conditioning optics configured to expand a cross section of the beam and to shape the beam to fill a rectangular area that matches an active area of the phase modulator.

24. The apparatus according to claim 23 wherein the conditioning optics comprise an aperture located and sized to block light that would fall outside of the active area of the phase modulator.

25. The apparatus according to claim 21 comprising an amplitude modulator in the optical path.

26. The apparatus according to claim 25 wherein the amplitude modulator is operable to refine the pattern of light, and wherein the controller is configured to control the amplitude modulator to straighten edges or remove high intensity artifacts from the pattern.

27. The apparatus according to claim 21 comprising a source of unsteered light operable to illuminate all or part of a top surface of the powder bed.

28. The apparatus according to claim 27 wherein the source of unsteered light comprises optical elements arranged to collect light that is specularly reflected by the phase modulator and to deliver the light that has been specularly reflected by the phase modulator to the location of the powder bed.

29. The apparatus according to claim 28 wherein the source of unsteered light comprises a beam splitter arranged to split light from the beam emitted by the light source.

30. The apparatus according to claim 28 wherein the controller is configured to adjust relative amounts of the unsteered light and the light that has been phase shifted by the phase modulator.

31. The apparatus according to claim 21 wherein the controller is configured to apply feedback control by modifying the phase pattern in response to feedback from one or more sensors.

32. The apparatus according to claim 31 wherein the controller is configured to process the feedback from the one or more sensors to determine that an area of a current layer of the powder bed has been solidified.

33. The apparatus according to claim 31 wherein the feedback control includes controlling a temperature of areas of the powder bed that are to be solidified in a current layer and controlling a temperature of areas of the powder bed that are not to be solidified in the current layer using separate feedback loops.

34. The apparatus according to claim 21 wherein the controller is configured to dynamically vary a phase pattern of the phase modulator by applying a first phase pattern that provides defocused or uniform illumination of an area of the powder bed followed by a second phase pattern that provides focused illumination of one or more areas of the powder bed.

35. The apparatus according to claim 21 wherein the light source and optical path are provided by a first exposure unit and the apparatus comprises a plurality of exposure units each comprising a corresponding light source and a corresponding optical path.

36. The apparatus according to claim 35 wherein some of the plurality of exposure units are configured to deliver unsteered light and/or defocused steered light to the powder bed.

37. The apparatus according to claim 21 wherein the controller is configured to adjust the energy density profile of the light incident at the location of the powder bed by one or more of:
changing a power of the light source;
changing the phase pattern to reduce an optical power directed to areas of the powder bed that should not be solidified if those areas have a temperature that exceeds a threshold; and/or
interrupting delivery of light from the beam to the location of the powder bed.

38. The apparatus according to claim 21 comprising a beam shaping unit in the optical path between the light source and the phase modulator wherein the beam shaping unit includes optical elements that expand and shape the beam to cover the active area of the phase modulator.

39. The apparatus according to claim 21 wherein the controller is configured to establish corrective phase patterns to compensate for thermal lensing for different temperatures of components of the apparatus and/or different optical power levels and to apply the corrective phase patterns to the phase modulator based on one or more measured component temperatures and/or a current optical power level.

40. The apparatus according to claim 21 comprising a scanning unit in the optical path, the scanning unit operable to scan the beam of light in at least one dimension across the location of the powder bed.

41. The apparatus according to claim 40, wherein the scanned beam is focused to a scanned spot by one or more lenses in the optical path and wherein the controller is configured to adjust the phase pattern on the phase modulator to vary a distribution of optical energy in the scanned spot based on one or more of:
how close is the location of the scanned spot to an edge of an area of the powder bed that is to be a solid area;
how small are features of a part being made that are close to a current location of the scanned spot;
is the scanned spot approaching a boundary between an area of the powder bed that should be solidified and an area of the powder bed that should not be solidified;
how recently were other points scanned that are adjacent to the point currently illuminated by the scanned spot;
properties of a material of the powder bed; and
a radius of curvature of a path along which the scanned spot is being scanned.

42. The apparatus according to claim 40 wherein the scanned beam is focused to a scanned spot by one or more lenses in the optical path and wherein the controller is configured to selectively apply a phase pattern to the phase modulator that acts to flatten a distribution of optical energy in the scanned spot or make the distribution of optical energy more peaked.

43. The apparatus according to claim 40 wherein the scanned beam is focused to a scanned spot by one or more lenses in the optical path and wherein the controller comprises stored configuration data that associates preferred beam shapes to each of a plurality of different part features and is configured to selectively apply a phase pattern to the phase modulator that configures the phase modulator to provide an optical energy distribution for the scanned spot that has a shape corresponding to a part feature at a current location of the scanned spot.

44. The apparatus according to claim 40 wherein the scanned beam is focused to a scanned spot by one or more lenses in the optical path and wherein the controller comprises stored configuration data that associates preferred beam shapes to each of a plurality of different materials and is configured to selectively apply a phase pattern to the phase modulator that configures the phase modulator to provide an optical energy distribution for the scanned spot that has a shape corresponding to a material present in the powder bed at a current location of the scanned spot.

45. The apparatus according to claim 40 wherein the scanned beam is focused to a scanned spot by one or more lenses in the optical path and wherein the controller is configured to process patterns for layers of a part being made to identify features, materials and/or microstructure that lie along different scan lines and to set a sequence of beam shapes and/or other beam parameters to use for the parts of each scan line corresponding to the different features and to control the beam in real time as the scanned spot is scanned along the scan line by setting the phase modulator to provide phase patterns that shape an optical energy distribution of the scanned spot to provide the sequence of beam shapes.

46. The apparatus according to claim 21 wherein the controller is configured to compensate for changes in steering efficiency of the phase modulator by measuring a distribution of optical energy in a light field steered by the phase modulator and adjusting control signals applied to control the phase modulator to compensate for differences between the measured distribution of optical energy and a desired distribution of the optical energy.

47. The apparatus according to claim 21 comprising a process sensor element arranged to monitor a portion of the beam that is incident on the phase modulator at a location upstream from the phase modulator.

48. The apparatus according to claim 21 comprising a modulator sensor having an output signal indicative of a level of light reflected by the phase modulator wherein the controller is configured to control a power output of the light source based on the output signal of the modulator sensor.

49. A computer program product comprising a computer readable medium carrying computer executable instructions that when executed by a data processor of a controller of apparatus of claim 21 cause the data processor to control the apparatus defined in claim 21.

50. A method of additive manufacturing, the method comprising:
guiding light from a light source to a location of a powder bed on an optical path that includes a phase modulator;
controlling the phase modulator to apply a 2D pattern of phase shifts to the light, the phase shifts steering the light onto the powder bed to yield a desired optical power distribution on the powder bed; and
the optical power distribution selectively solidifying areas in a top layer of the powder bed.
